(19) United States
(12) Patent Application Publication
(10) Pub. No.: US 2005/0138467 A1
(43) Pub. Date: Jun. 23, 2005

(54) Hardware detection for switchable storage

(75) Inventors: Eric Y. Theriault, Montreal (CA); Le Huan Tran, Pointe-Claire (CA)

Correspondence Address: GATES & COOPER LLP;HOWARD HUGHES CENTER, 6701 CENTER DRIVE WEST, SUITE 1050, LOS ANGELES, CA, 90045, US

(73) Assignee: AUTODESK CANADA INC.

(21) Appl. No.: 11/013,662

(22) Filed: Dec. 16, 2004

(30) Foreign Application Priority Data
Dec. 20, 2003 (GB) 03 29 604.3

(51) Int. Cl. G06F 12/16

(52) U.S. Cl. 714/6; 711/114

(57) ABSTRACT

A data processing apparatus, comprising a plurality of host computers, a plurality of storage devices and a switch; wherein each host computer and each storage device is connected to said switch such that each host computer is provided with switchable storage; each host computer has internal storage on which is stored first data that is necessary for said communication between itself and the storage devices to which it is connected, and second data that relates to at least one of said host computers and storage devices; and each host computer is configured to identify each of said host computers that is missing from said second data; and request said first data from each of said identified host computers in order to construct said second data.

### CROSS-REFERENCE TO RELATED APPLICATION

This application claims the benefit under 35 U.S.C. §119 of the following co-pending and commonly assigned foreign patent application, which application is incorporated by reference herein:

United Kingdom Application No. 03 29 604.3 entitled, “DATA PROCESSING”, by Eric Theriault and Le Huan Tran, filed on Dec. 20, 2003.

This application is related to the following issued and commonly-assigned patent, which patent is incorporated by reference herein:

U.S. Pat. No. 6,118,931, filed Apr. 11, 1997 and issued on Sep. 12, 200, by Raju C. Bopardikar, entitled “Video Data Storage”, attorneys' docket number 30566.207-US-U1.

### BACKGROUND OF THE INVENTION

1. Field of the Invention

The invention relates to a data processing environment in which switchable storage is provided.

2. Description of the Related Art

Devices for the real time storage of image frames, derived from video signals or derived from the scanning of cinematographic film, are disclosed in the present applicant's U.S. Pat. No. 6,118,931 which patent is incorporated by reference herein. In the aforesaid patent, systems are shown in which image frames are stored at display rate by accessing a plurality of storage devices in parallel under a process known as striping.

Recently, there has been a trend towards networking a plurality of computers of this type. An advantage of connecting computers of this type in the network is that relatively low powered machines may be deployed for relatively simple tasks, such as the transfer of image frames from external media, thereby allowing the more sophisticated equipment to be used for the more processor-intensive tasks such as editing and compositing etc. However, a problem then exists in that data may have been captured to a first file storage system having a direct connection to a first processing system but, for subsequent manipulation, access to the stored data is required by a second processing system.

The solution of switchable storage, wherein each host computer and each storage device is connected to a switch and the switch is used to provide a connection between any host and any storage device requires that certain information be known on each host about the hardware capabilities of all the other hosts and the storage devices on the network. Currently this information must be entered manually which is error-prone.

### BRIEF SUMMARY OF THE INVENTION

According to a first aspect of the present invention there is provided data processing apparatus, comprising a plurality of host computers, a plurality of storage devices and a switch; wherein each host computer and each storage device is connected to said switch such that each host computer is provided with switchable storage; each host computer has internal storage on which is stored first data that is necessary for said communication between itself and the storage devices to which it is connected, and second data that relates to at least one of said host computers and storage devices; and each host computer is configured to identify each of said host computers that is missing from said second data; and request said first data from each of said identified host computers in order to construct said second data.

### BRIEF DESCRIPTION OF THE SEVERAL VIEWS OF THE DRAWINGS

FIG. 1 shows a data processing environment;

FIG. 2 shows a host as shown in FIG. 1;

FIG. 3 shows a computer as shown in FIG. 2;

FIG. 4 shows a framestore as shown in FIG. 1;

FIG. 5 illustrates an example of striping onto the framestore shown in FIG. 4;

FIG. 6 shows a diagrammatic representation of a switch shown in FIG. 1;

FIG. 7 shows steps carried out by the host shown in FIG. 2 in order to carry out data processing;

FIG. 8 details the contents of the memory shown in FIG. 3 during steps shown in FIG. 7;

FIG. 9 details host data in memory as shown in FIG. 8;

FIG. 10 details framestore data in memory as shown in FIG. 8;

FIG. 11 details storage data in memory as shown in FIG. 8;

FIG. 12 details patch panels data as shown in FIG. 11;

FIG. 13 details hosts data as shown in FIG. 11;

FIG. 14 details RAIDs data as shown in FIG. 11;

FIG. 15 details file systems data as shown in FIG. 11;

FIG. 16 details local configuration data in memory as shown in FIG. 8;

FIG. 17 details network configuration data in memory as shown in FIG. 8;

FIG. 18 details steps carried out by a network configuration daemon shown in FIG. 8;

FIG. 19 details steps carried out in FIG. 18 to create network configuration data;

FIG. 20 details steps carried out in FIG. 18 to process a received interrupt;

FIG. 21 details steps carried out by a local configuration daemon shown in FIG. 8;

FIG. 22 details steps carried out in FIG. 21 to process a received interrupt;

FIG. 23 details steps carried out in FIG. 22 to update local and network configuration data shown in FIGS. 16 and 17;

FIG. 24 details steps carried out in FIG. 7 to load images from a framestore into memory;

FIG. 25 details steps carried out in FIG. 24 to display available framestores on the VDU shown in FIG. 2;

FIG. 26 illustrates a GUI displayed during steps carried out in FIG. 25;

FIG. 27 details steps carried out in FIG. 24 to configure switchable storage;

FIG. 28 illustrates a GUI displayed during steps carried out in FIG. 27;

FIG. 29 details steps carried out in FIG. 27to configure switchable storage;

FIG. 30 details steps carried out in FIG. 29 to add a patch panel component;

FIG. 31 details steps carried out in FIG. 29 to configure a host object;

FIG. 32 details steps carried out in FIG. 31 to create storage data for a host object;

FIG. 33 details steps carried out in FIG. 24 to perform a framestore swap; and

FIG. 34 details steps carried out in FIG. 33 to send instructions to the patch panel shown in FIG. 1.

### WRITTEN DESCRIPTION OF THE BEST MODE FOR CARRYING OUT THE INVENTION

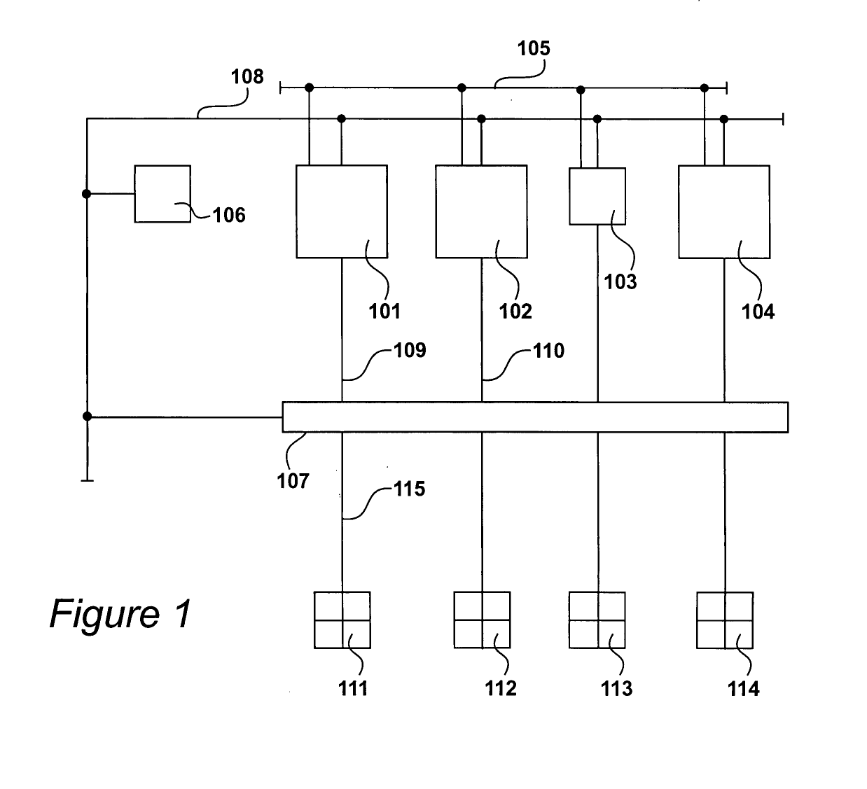

FIG. 1

FIG. 1 shows a data processing environment in which switchable storage is provided. Four host computers 101, 102, 103 and 104 are connected to an Ethernet 105, as is a Network Attached Storage computer (NAS) 106 and a switch, which in this example is patch panel 107. The host computers 101 to 104, known simply as hosts, are also connected to a High Performance Parallel Interface (HiPPI) network 108. Each host is connected to the patch panel 107 by a fiber channel connection; thus for example host 101 is connected by connection 109 and host 102 by connection 110.

Also in the data processing environment are four framestores 111, 112, 113 and 114. These are also connected to the patch panel 107 by a fiber channel connection; for example framestore 111 is connected by connection 115. Each framestore 111-114 is made up of a number of storage devices.

In this example the data processing environment is provided in order to process image data. The host computers are used to manipulate images, usually film or video but also stills, to provide “special effects” and to edit together clips of images. The framestores 111-114 are used to store the images. A typical digitized television-quality frame has a size of approximately one megabyte, and so with thirty frames per second, a clip of only one minute requires nearly two gigabytes of storage. High definition film or television images require much more. For this reason image data is not stored permanently in the data processing environment. Images to be manipulated are captured and stored on the framestores 111-114 before editing, and rendered and archived to tape or film once the editing is finished.

In this example, host 101 is used to capture and archive material for use by the other hosts. This is a time-consuming but non-creative process.

Host 102 is an expensive, high-resolution effects machine. It can manipulate very large images in real-time and is used by artists to create the more difficult effects.

Host 103 is an editing machine. It is used to edit together clips of images, some of which may have had effects applied to them, in order to produce a finished project, which could be a scene from a film, an advertisement, a music video and so on.

In this example, hosts 101 to 103, together with framestores 111 to 113, have been in the switchable storage environment for some time. However, host 102 is very much in demand and so a new machine is now being added to the network. Host 104 is a lower-cost, lower-resolution machine. It will be used to create preliminary effects that do not require the high-resolution capacity of host 102.

In a switchable storage environment each host 101-104 and each framestore 111-114 is connected to patch panel 107, which in this example is a fiber channel arbitrated loop patch panel that creates physical connections between the ports that the hosts and framestores are connected to. Thus, for example, framestore 111 might be connected, via patch panel 107, to host 101, which captures images to it from a video cassette player. Host 101 then performs a framestore swap with host 102, which for example might be connected to host 112, by instructing patch panel 107 to connect its ports to those of framestore 112 and to connect the ports of host 102 to those of framestore 111.

After the framestore swap, host 101 is connected to framestore 112 and host 102 is connected to framestore 111. The images are still on framestore 111, and so the user of host 102 adds effects to them. Then, host 103, which is connected to framestore 113, swaps with host 102, which means that host 102 controls framestore 113 and host 103 controls framestore 111. The user of host 103 edits the images to produce the finished project. Hosts 101 and 103 then swap framestores, resulting in host 101 controlling framestore 111 again and host 103 controlling framestore 112. Host 101 can then render the images onto tape, thus freeing up framestore 111 for new material.

Thus, switchable storage enables “virtual transfer” of data—from the user's point of view the images he requires are available instantly without waiting for them to be transferred over one of the networks. However, if a user requires only a few images from a framestore to which he is not connected he can request a copy of them via Ethernet 105, rather than swapping framestores.

NAS 106 stores the metadata for the images that are stored on framestores 111 to 114. When an artist creates effects or edits images together, the images themselves, as stored on the framestores, are not actually changed. Instead, metadata indicating a series of transformations is stored on the NAS and these transformations are applied to the images whenever they are viewed or rendered. Thus, although it appears to the user that the images have changed, in fact they have not. This allows the undoing of any effects or editing that have been applied and ensures that over-manipulation of the images does not degrade their quality. Thus, in order to discover what images are stored on the framestores each host has only to access the metadata stored on NAS 106.

Although in this example the data processing environment is used to manipulate images, the environment is applicable to any situation in which large amounts of data need to be transferred between host computers.

In a switchable storage environment, any host can be connected to any framestore, but for ease of description, host 101 will be considered to be connected to framestore 111, host 102 to framestore 112, host 103 to framestore 113 and host 104 to framestore 114. The terminology used is that a host is connected to its respective framestore and that a framestore is connected to its controlling host.

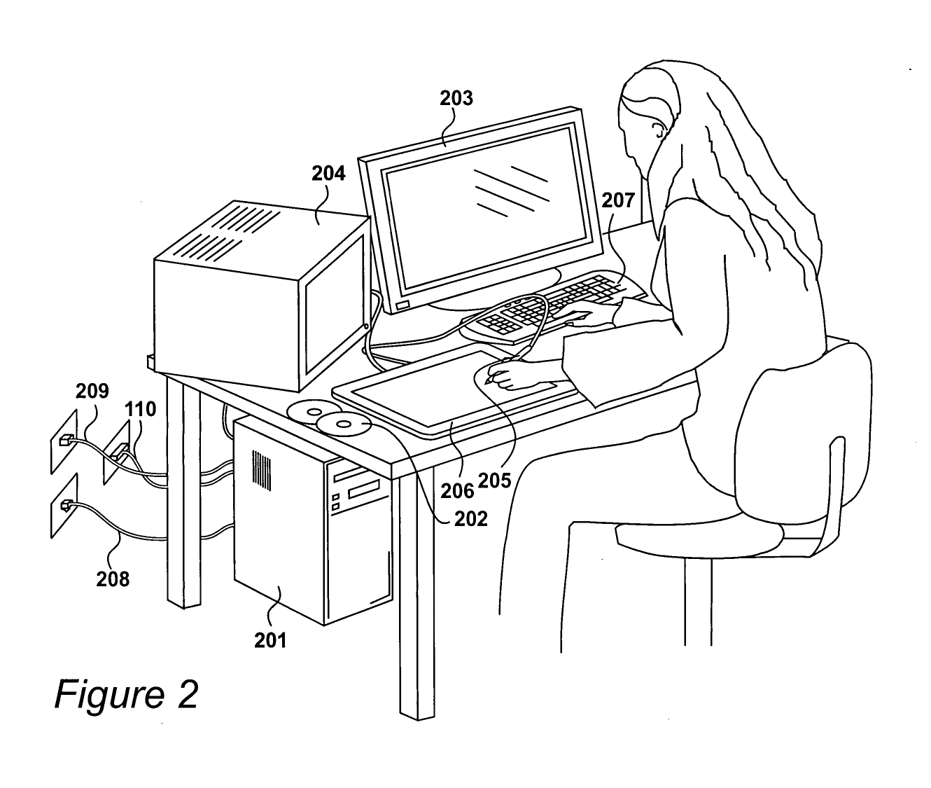

FIG. 2

A high-resolution effects machine, such as host 102, is illustrated in FIG. 2, based around an Octane® 2 computer 201. Program instructions executable within the computer 201 may be supplied to said computer via a data carrying medium, such as a CD ROM 202.

A user is provided with a visual display unit 203 and a high quality broadcast quality monitor 204. Input commands are generated via a stylus 205 applied to a graphics tablet 206 and may also be generated via a keyboard 207.

Computer 201 is connected to the Ethernet 105 by network connection 208, to the HiPPI network 109 by network connection 209 and to the patch panel 107 by fiber channel connection 110.

Hosts 101, 103 and 104 are similar, except that host 101 is provided with apparatus for capturing and archiving images and host 104 is based around a smaller computer such as an O2®.

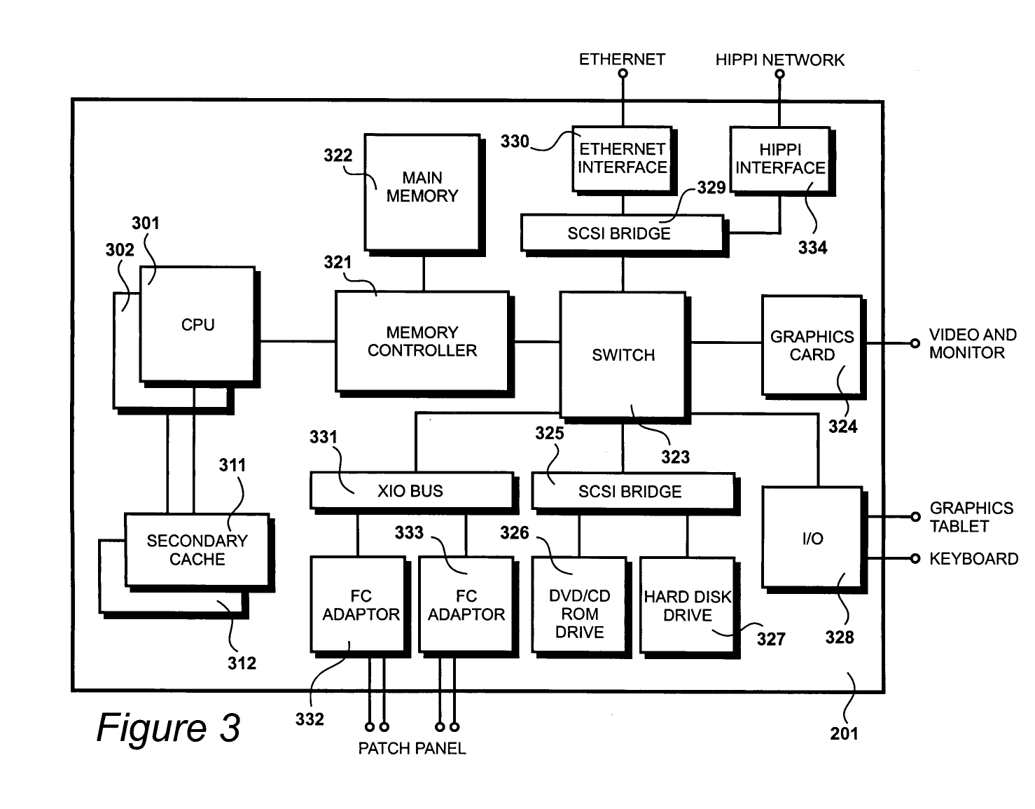

FIG. 3

The computer 201 shown in FIG. 2 is detailed in FIG. 3. Computer 201 comprises two central processing units 301 and 302 operating in parallel. Each of these processors 301 and 302 has a dedicated secondary cache memory 311, 312 that facilitates per-CPU storage of frequently used instructions and data. Each CPU 301 and 302 further includes separate primary instruction and data cache memory circuits on the same chip, thereby facilitating a further level of processing improvement. A memory controller 321 provides a common connection between the processors 301 and 302 and a main memory 322. The main memory 322 comprises eight gigabytes of synchronous dynamic RAM.

The memory controller 321 further facilitates connectivity between the aforementioned components of the computer 201 and a high bandwidth non-blocking crossbar switch 323. The switch 323 makes it possible to provide a direct high capacity connection between any of several attached circuits, including a graphics card 324. The graphics card 324 generally receives instructions from the processors 301 and 302 to perform various types of graphical image rendering processes, resulting in frames, clips and scenes being rendered in real time.

A SCSI bridge 325 facilitates connection between the crossbar switch 323 and a DVD/CDROM drive 326. The DVD drive 326 provides a convenient way of receiving large quantities of instructions and data, and is typically used to install instructions for the processing system 201 onto a hard disk drive 327. Once installed, instructions located on the hard disk drive 327 may be transferred into main memory 322 and then executed by the processors 301 and 302. An input output (I/O) bridge 328 provides an interface for the graphics tablet 206 and the keyboard 207, through which the user is able to provide instructions to the computer 201.

A second SCSI bridge 329 facilitates connection between the crossbar switch 323 and network communication interfaces. Ethernet interface 330 is connected to the Ethernet network 105 and medium bandwidth interface 334 is connected to HiPPI network 108.

An XIO bus 331 facilitates connection between cross bar switch 323 and two fiber channel arbitrated loop (FC-AL) adapters 332 and 333. These are connected to patch panel 107.

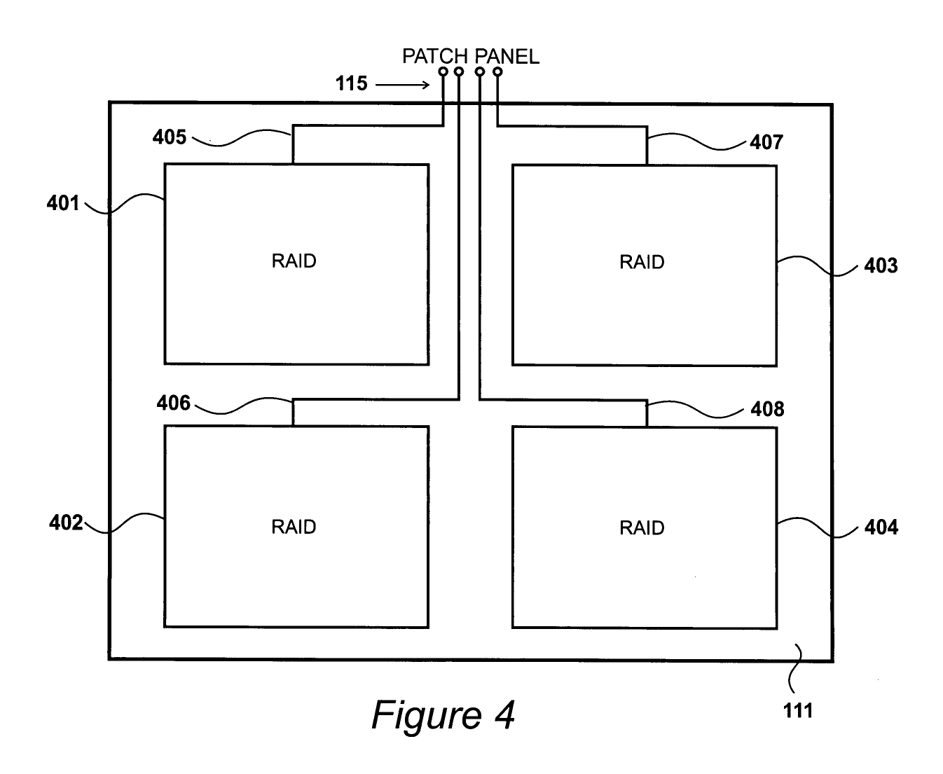

FIG. 4

FIG. 4 details framestore 111. Framestores 112 to 114 are substantially similar. Framestore 111 is made up of a plurality of storage devices. In this example, it is composed of four redundant arrays of inexpensive disks (RAIDs) 401, 402, 403 and 404, each having sixteen thirty-six-gigabyte disk drives. Some of these disks are parity disks and two are spares. Each RAID 401-404 has a fiber channel connection, so that RAID 401 has connection 405, RAID 402 has connection 406, RAID 403 has connection 407 and RAID 404 has connection 408. These four connections together make up fiber channel connection 115 that connects framestore 111 to patch panel 107.

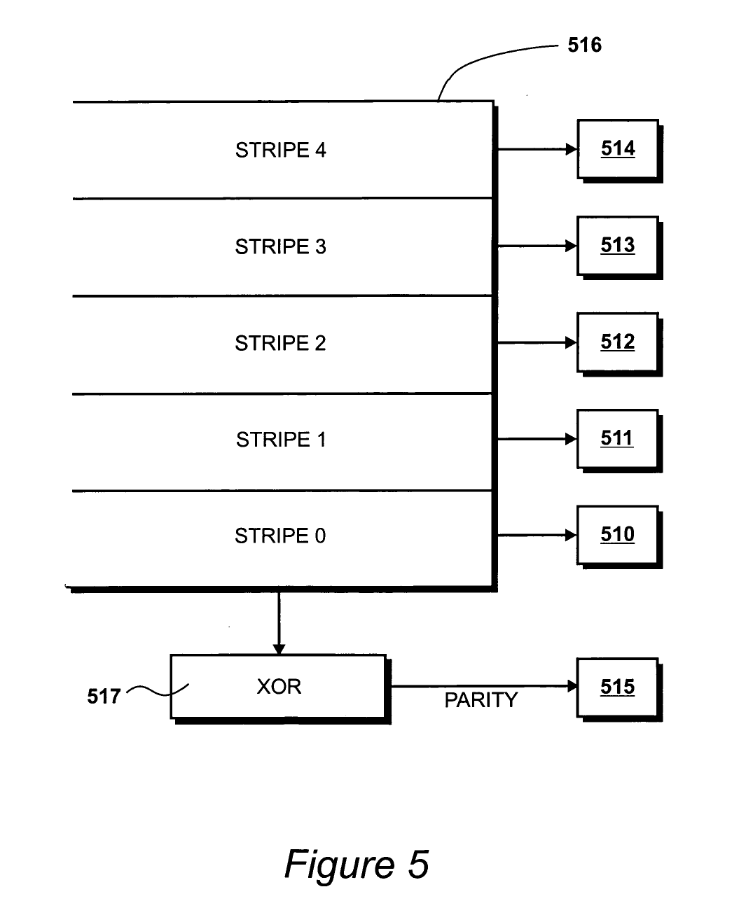

FIG. 5

FIG. 5 illustrates an example of striping, a method used to store image data on an array of disks. As described with reference to FIG. 4, a RAID has sixteen disk drives. Five of these are illustrated diagrammatically as drives 510, 511, 512, 513 and 514. In addition to these five disks configured to receive image data, a sixth redundant disk 515 is provided. An image field 516, stored in a buffer within memory, is divided into five stripes identified as stripe zero, stripe one, stripe two, stripe three and stripe four. The addressing of data from these stripes occurs using similar address values with multiples of an off-set value applied to each individual stripe. Thus, while data is being read from stripe zero, similar address values read data from stripe one but with a unity off-set. Similarly, the same address values are used to read data from stripe two with a two unit off-set, with stripe three having a three unit off-set and stripe four having a four unit off-set. In a system having many storage devices of this type and with data being transferred between storage devices, a similar striping off-set is used on each system.

As similar data locations are being addressed within each stripe, the resulting data read from the stripes is XORed together by process 517, resulting in redundant parity data being written to the sixth drive 515. Thus, as is well known in the art, if any of disk drives 510 to 514 should fail it is possible to reconstitute the missing data by performing a XOR operation upon the remaining data. Thus, in the configuration shown in FIG. 5, it is possible for a damaged disk to be removed, replaced by a new disk and the missing data to be re-established by the XORing process. Such a procedure for the reconstitution of data in this way is usually referred to as disk healing.

Frames of different resolutions may be striped across different numbers of disks, or across the same number of disks with different size stripes. In addition, a framestore may be configured to accept only frames of a particular resolution, hard-partitioned to accept more than one resolution but in fixed amounts, dynamically soft-partitioned to accept more than one resolution in varying amounts or set up in any other way. In this embodiment striping is controlled by software within the editing system but it may also be controlled by hardware within each RAID.

These RAIDs and, collectively, framestores, are examples of storage devices. In other embodiments (not shown) the storage devices may be any other system which allows storage of a large amount of image data and real-time access of that data by a connected host computer.

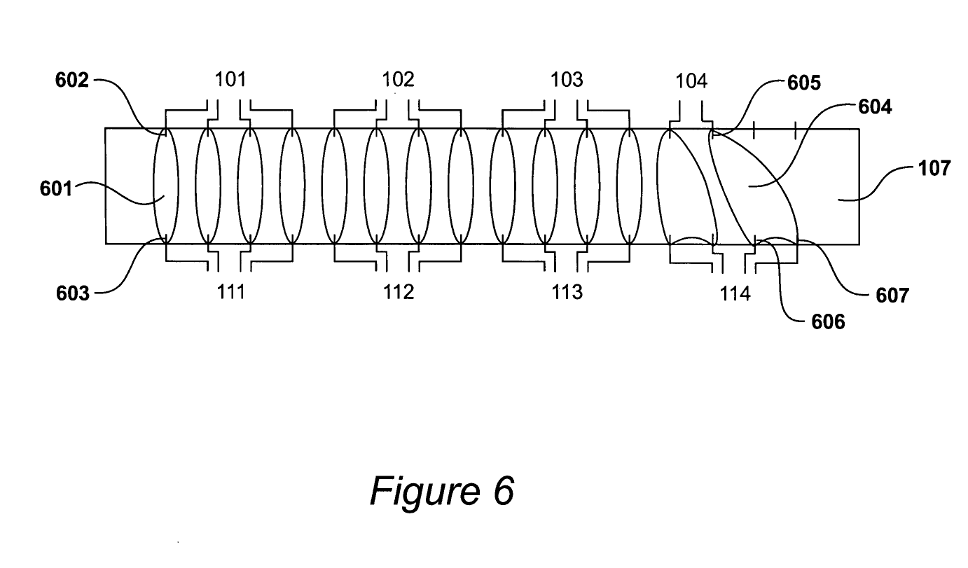

FIG. 6

FIG. 6 shows a diagrammatic representation of patch panel 107. It has thirty-two ports, sixteen of which are used for hosts and sixteen of which are used for framestores. In this example, each of hosts 101 to 103 and each of framestores 111 to 114 requires four ports, but host 104 only has two fiber channel adapters and therefore only requires two ports. Currently, host 101 is connected to framestore 111, host 102 is connected to framestore 112, host 103 is connected to framestore 113 and host 104 is connected to framestore 114. However, this is only for ease of illustration and in a switchable storage environment any host 101-104 could be connected to any framestore 111-114.

As shown by the connection between host 101 and framestore 111, when a host and a framestore have the same number of adapters and therefore the same number of ports, a two-port zone is created between corresponding ports. Thus, for example, a two-port zone 601 is created between port 602, connected to host 101, and port 603, connected to framestore 111. This means that the output from port 602 is the input to port 603 and vice versa.

When a two-adapter host is connected to a four-adapter framestore, as is the case with host 104 and framestore 114, two three-port zones are created. Thus, for example, a three-port zone 604 is created between port 605, connected to host 104, and ports 606 and 607, connected to framestore 114. This means that the output from port 605 is the input to port 606, the output from port 606 is the input to port 607 and the output from port 607 is the input to port 605.

In other embodiments it is possible that a framestore could require only two ports. In this case, if it were connected to a two-adapter host, two two-port zones would be created. If it were connected to a four-adapter host, two two-port zones would also be created and the remaining two ports on the host size would be looped back on themselves to create two one-port zones.

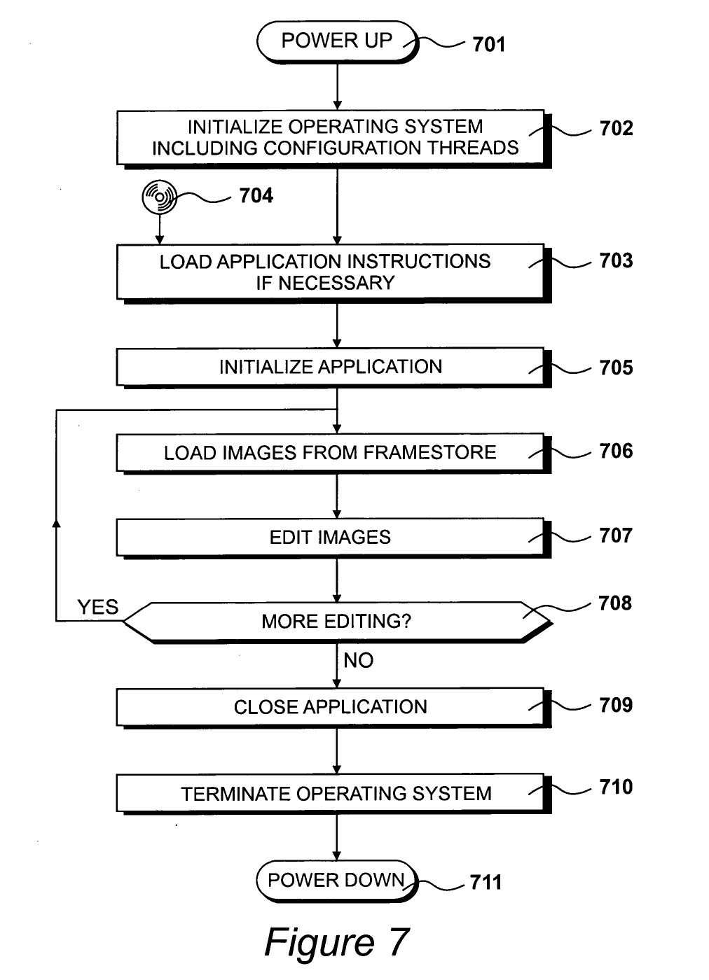

FIG. 7

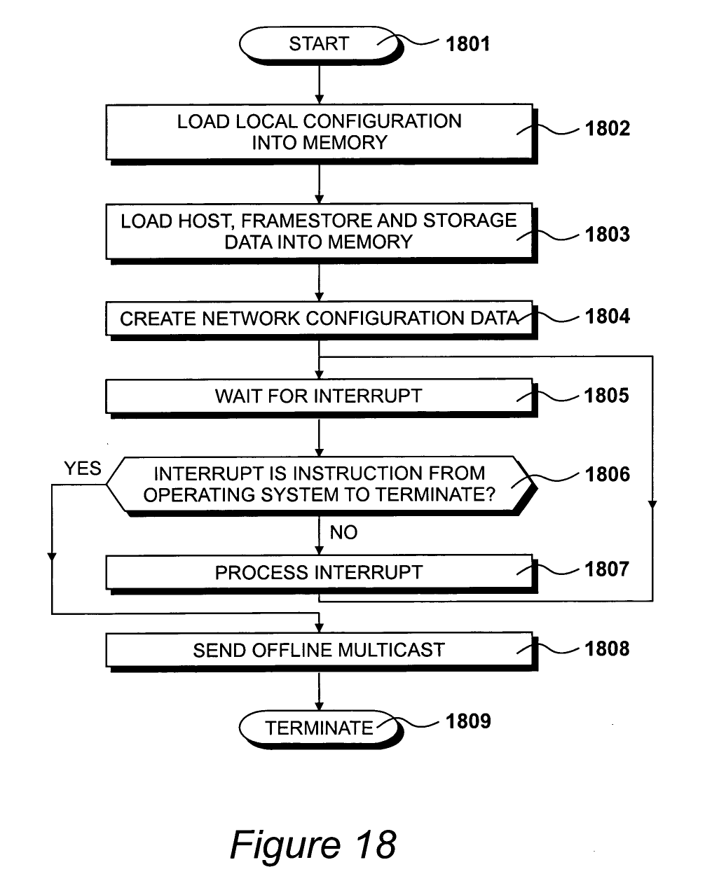

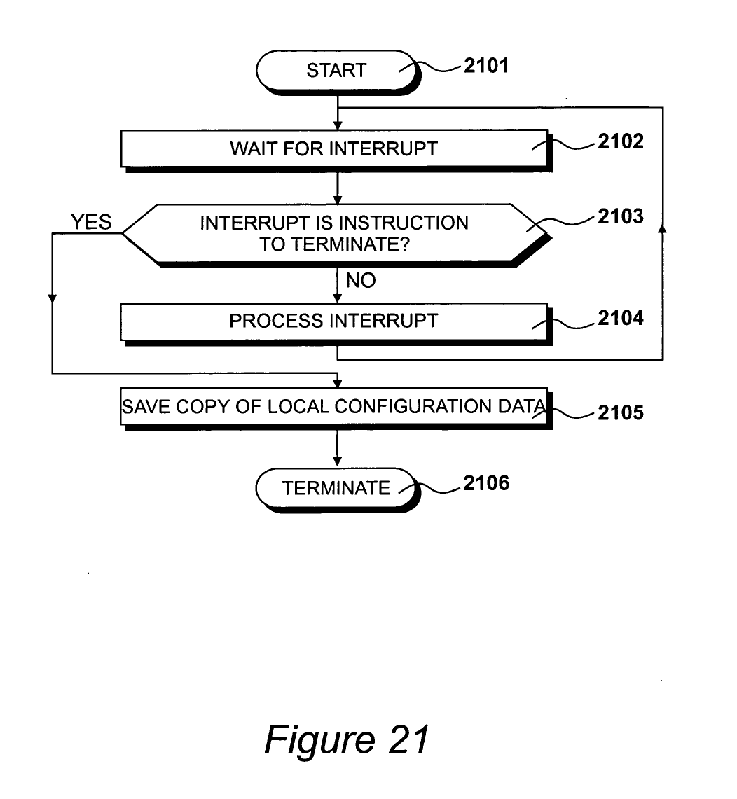

FIG. 7 shows steps carried out by host 102 in order to carry out image processing. At step 701, the computer is powered up and at step 702, the operating system is initialized, including starting up two configuration daemons that will be discussed further with reference to FIGS. 18 and 21.

At step 703, application instructions are loaded from CD-ROM 704 if necessary and at step 705, the application is initialized. In this example, the application is a high-resolution effects system. However, host 101 runs a media management system suitable for capturing and archiving material, host 103 runs an editing system and host 104 runs a lower-resolution effects program. Nevertheless, each runs the same operating system, part of which is a storage management system such that each host 101-104 is capable of basic project management, image transfer over the networks, initiating framestore swaps and so on.

At step 706, images are loaded into memory 322 from framestore 112 in order to be manipulated at step 707. At step 708, a question is asked as to whether more editing is to be carried out. If this question is answered in the affirmative, then control is returned to step 706 and more images are loaded. If it is answered in the negative, then at step 709 the application is closed. At step 710, the operating system is terminated and at step 711 the computer is powered down.

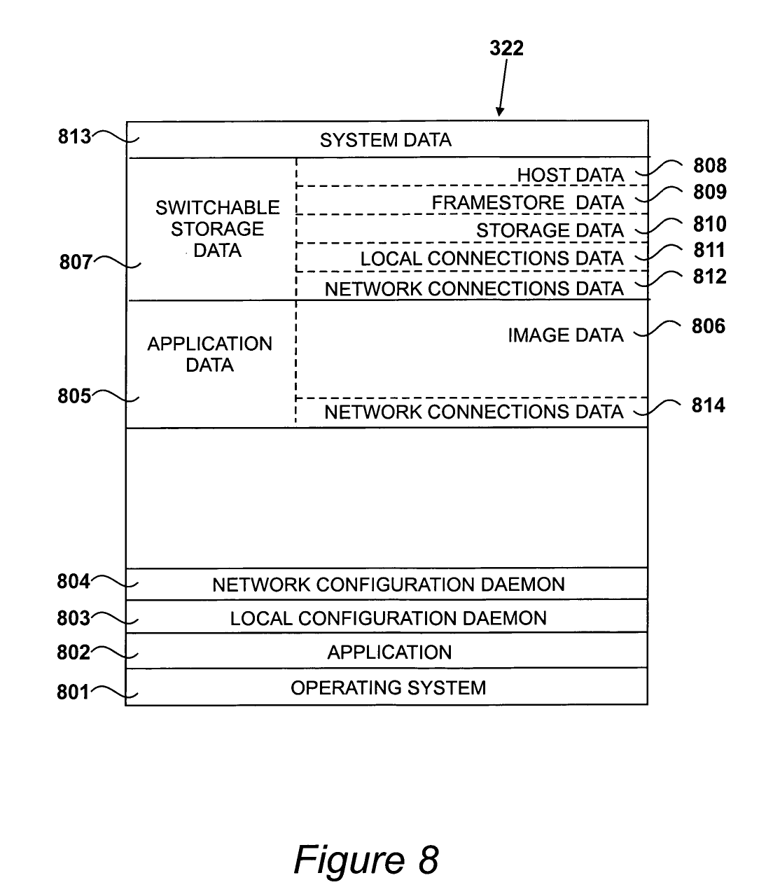

FIG. 8

FIG. 8 details the contents of main memory 322 during the editing step 707. The operating system executed by the computer resides in main memory as indicated at 801. The effects application executed by computer 201 is also resident in main memory as indicated at 802. A local configuration daemon is indicated at 803 and a network configuration daemon at 804. These daemons keep up to date records of the ways in which each framestore can be contacted and will be described further with reference to FIGS. 18 and 21.

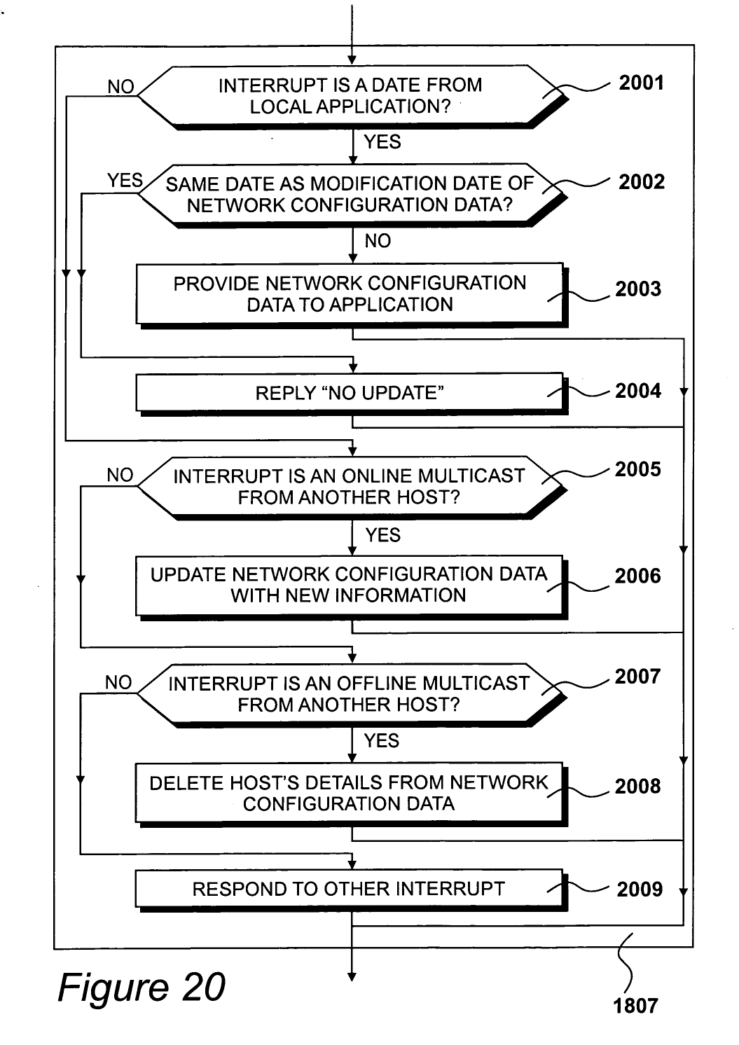

Application data 805 includes data loaded by default for the application and other data that the application will process, display and or modify, specifically including image data 806, if loaded, and a copy 814 of network configuration data 812, which may or may not be current. This will be explained further with reference to FIG. 20.

Since the operating system includes a storage management process the memory also includes storage management data 807. This includes host data 808 and framestore data 809, which contain certain properties of host 102 and its respective framestore, storage data 810 which contains the same properties of all the hosts and all the framestores, local connections data 811 which contains the interfaces of host 102 and network connections data 812 which contains the interfaces of all the hosts. System data 813 includes data used by the operating system 801.

The contents of the memories of editing systems 101, 103 and 104 are substantially similar. Each may be running a different editing application most suited to its needs but the application data on each includes data similar to that shown at 808 to 812.

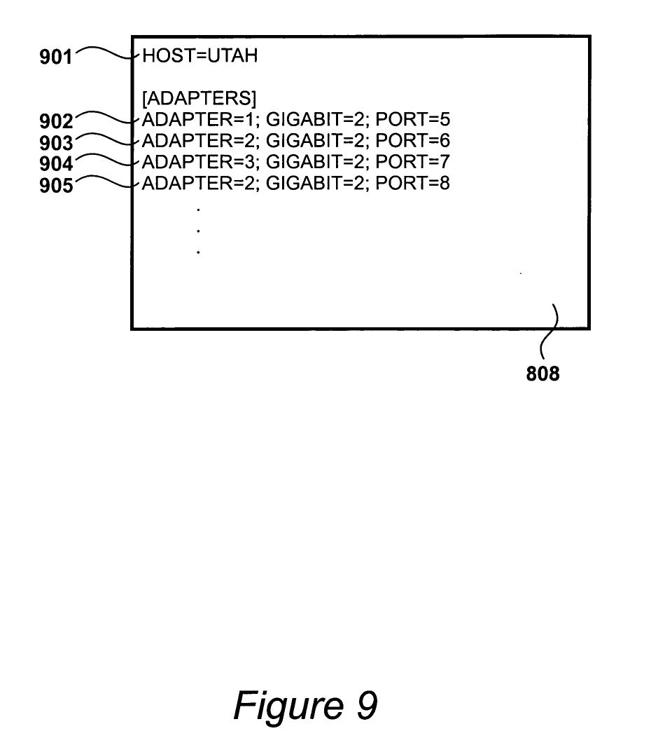

FIG. 9

FIG. 9 details host data 808. The information contained in host data 808 includes the name of the host at line 901 and details of its fiber channel adapters at lines 902, 903, 904 and 905.

The information given for each adapter first includes an identification within the computer for the adapter. This information is necessary because a host also contains SCSI adapters. Also, the gigabit setting is given, which is necessary because a 1 gigabit adapter cannot access 2 gigabit hardware. Lastly, the port to which the adapter is connected is given. This is necessary to control the patch panel 107.

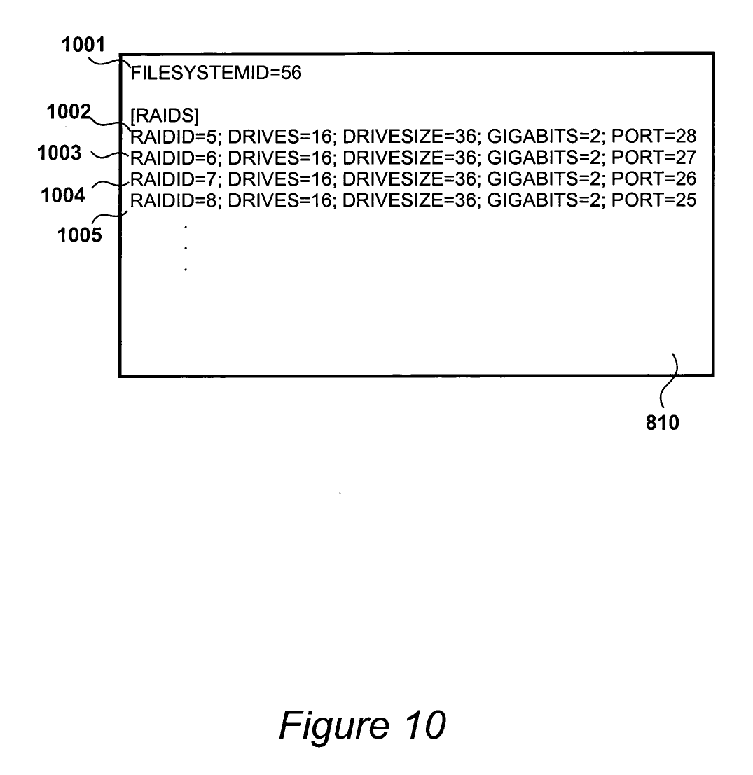

FIG. 10

FIG. 10 details framestore data 809. Line 1001 gives the ID of the filesystem that is resident on the framestore connected to host 102, which for example, is currently framestore 112. Lines 1002, 1003, 1004 and 1005 give the details of the RAIDs that make up the framestore, including the RAID ID, the number of drives in the RAID, the size of the drives, the gigabit characteristics of the RAID and the port which the adapter is connected to in patch panel 107.

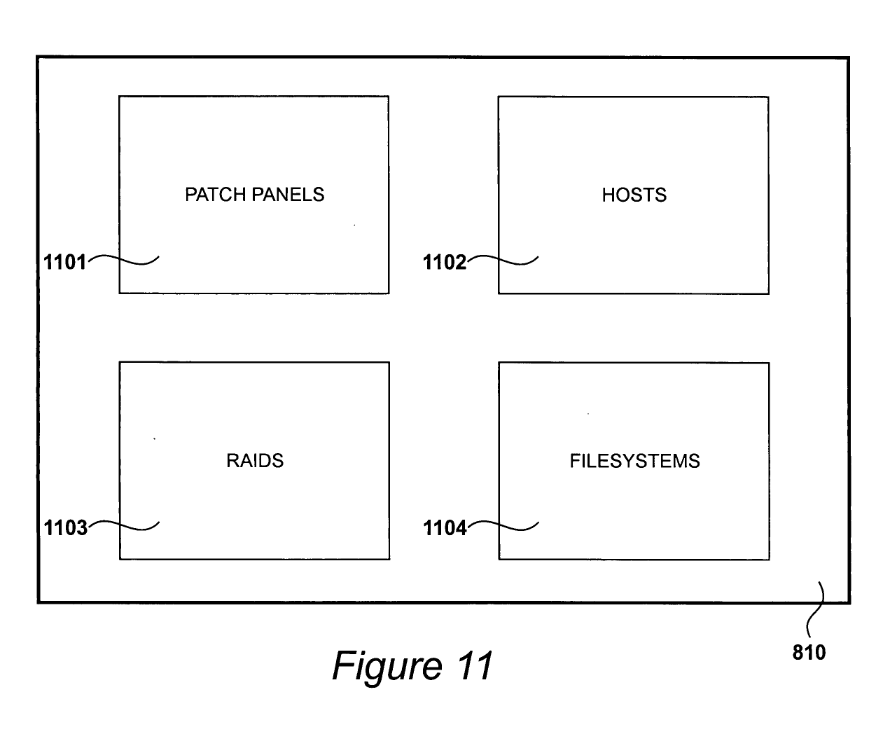

FIG. 11

FIG. 11 details storage data 810. This includes four kinds of data: patch panels data 1101, hosts data 1102, RAIDs data 1103 and filesystems data 1104. This data is similar to host and framestore data 808 and 809, except that it relates to all the hosts and framestores on the network that have been detected by host 102.

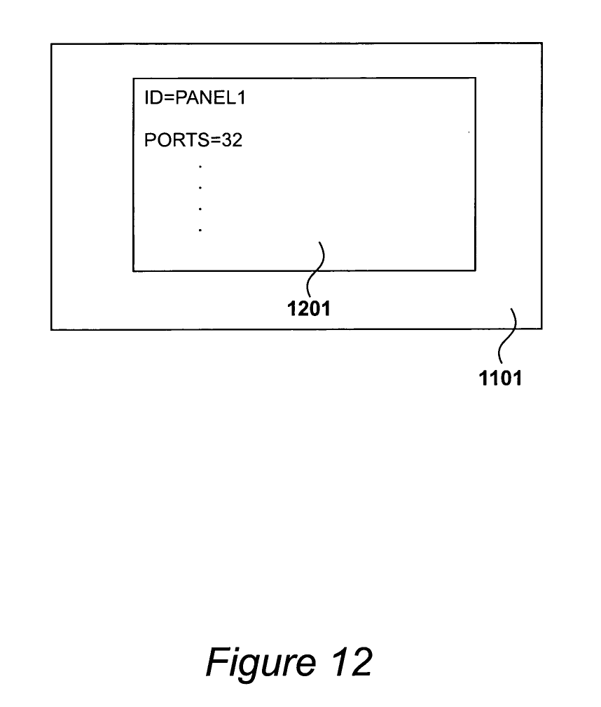

FIG. 12

FIG. 12 details patch panels data 1101. In this embodiment, there is only one patch panel per network and so there is a single patch panel object 1201. Amongst other configuration details, it gives an ID for the patch panel 107 and the number of ports on the patch panel.

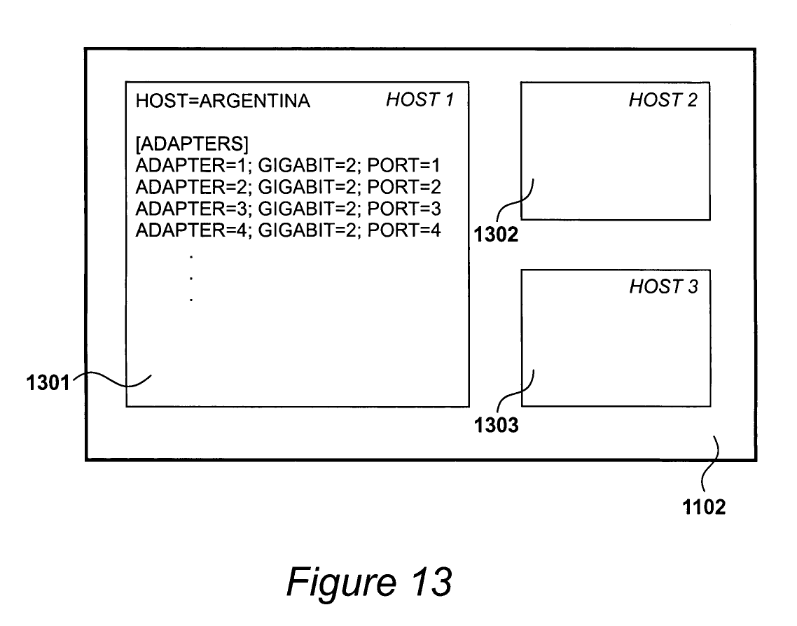

FIG. 13

FIG. 13 details hosts data 1102. This shows three host objects, one for each of hosts 101, 102 and 103. Host object 1301 represents host 101, host object 1302 represents host 102 and host object 1303 represents host 103. Host 104 is new on the network and host 102 has not yet detected it and thus it does not appear in storage data 810.

Only host object 1301 is shown in detail. It includes the name of the host and details of its adapters, and is in fact substantially identical to the host data stored on host 101.

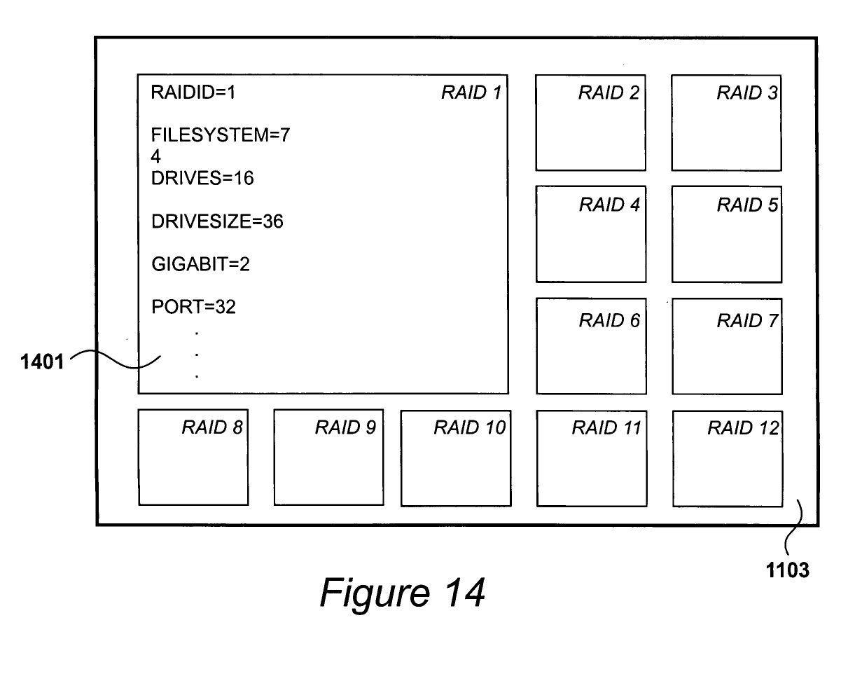

FIG. 14

FIG. 14 details RAIDs data 1103. It contains twelve RAID objects, one for each of the four RAIDs in the three framestores 111, 112 and 113. Only RAID object 1401, representing the first RAID in framestore 111, is shown in detail. It includes the ID of the RAID, the ID of the filesystem to which it belongs, the number of disk drives it contains, the size of each of these drives, its gigabit setting and the port in patch panel 107 to which it is connected. It thus contains information stored within the framestore data of the host currently controlling framestore 111, which in this example is host 101.

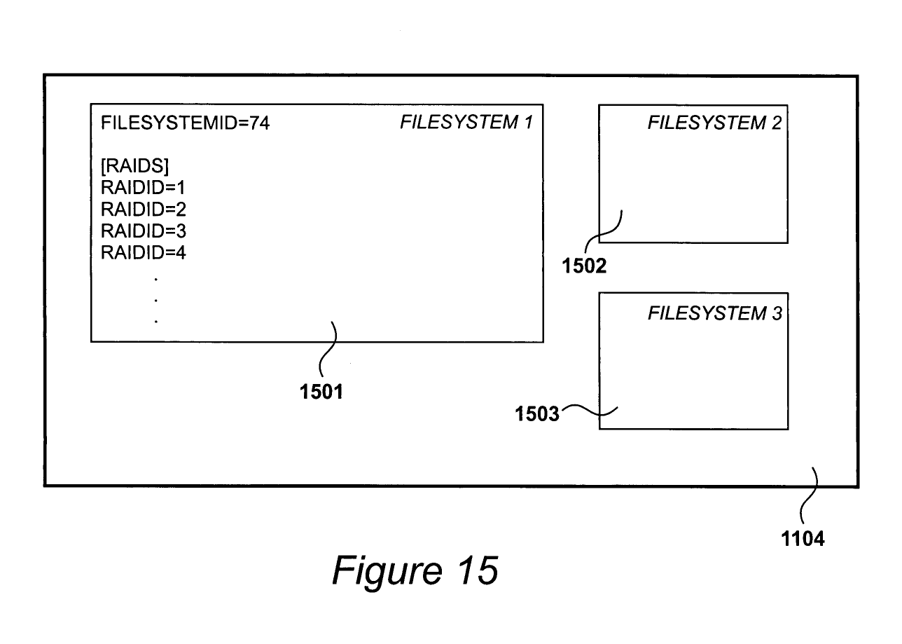

FIG. 15

FIG. 15 details filesystems data 1104. It contains three filesystem objects, object 1501 representing framestore 111, object 1502 representing framestore 112, and object 1503 representing framestore 113. It includes the ID of the filesystem and the IDs of the RAIDs that store the data making up the filesystem.

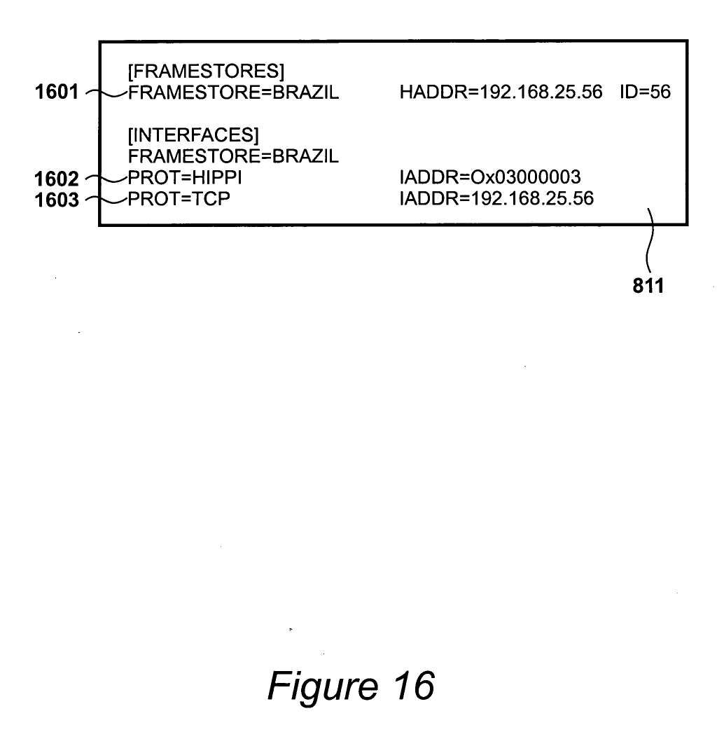

FIG. 16

FIG. 16 details local connections/configurations data 811. This contains the interfaces of host 102 and also the ID of the filesystem resident on the framestore which host 102 currently controls, for example framestore 112. Thus line 1601 gives the name of framestore 112, the Ethernet address (HADDR) of host 102, which is the address at which framestore 112 can currently be found, and the filesystem ID of framestore 112.

Lines 1602 and 1603 give information about the interfaces of host 102 and the protocols that are used for communication over the respective networks. As shown in FIG. 1, in this embodiment all the editing systems are connected to the Ethernet 105 and HiPPI network 108. Line 1602 therefore gives the address of the HiPPI interface of host 102 and line 1603 gives the Ethernet address.

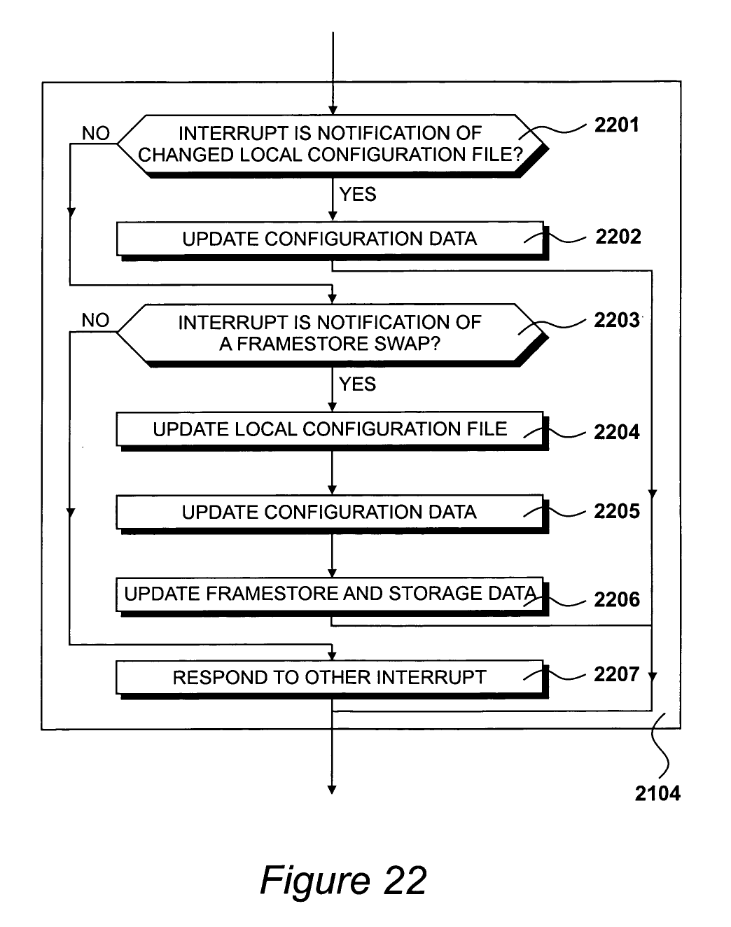

If host 102 swaps framestores with another editing system then it receives a message containing the ID of the framestore it now controls, as will be described with reference to FIG. 22. The ID is then changed in the local configuration data 811 and network connections/configuration data 812, and also in the framestore data 809.

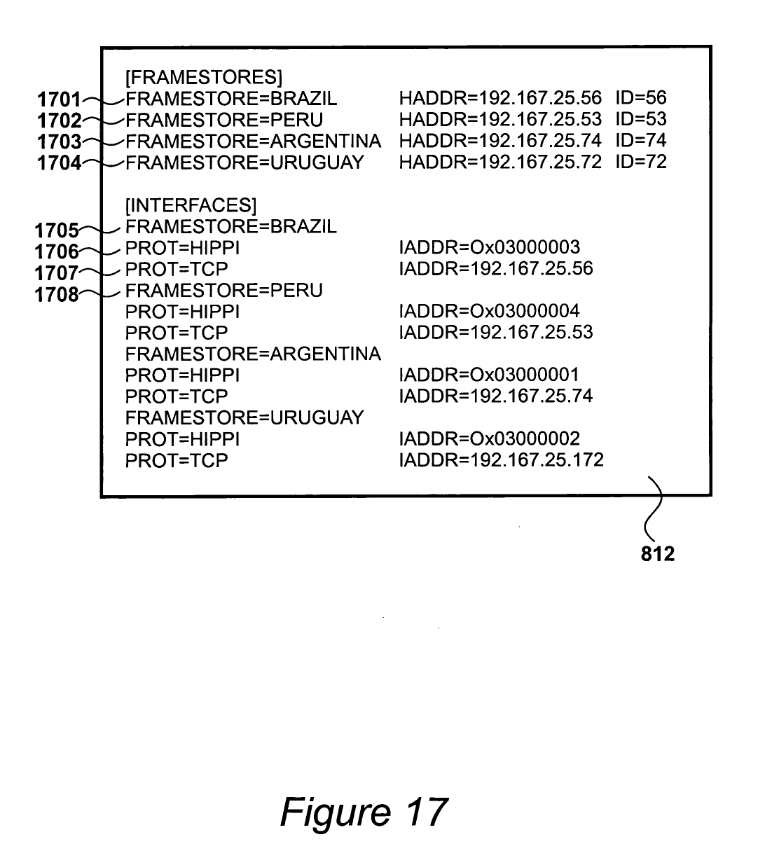

FIG. 17

FIG. 17 details network connections/configuration data 812. This contains the same data as local configuration file 811, but relating to every host and framestore on the network, even those that have not yet been detected by host 102. The first line 1701 relates to host 102 and its current respective framestore 112. Line 1702 has data representing host 104 and framestore 114, line 1703 data representing host 101 and framestore 111 and line 1704 data representing host 103 and framestore 113. For each, the Ethernet address of the host and the framestore ID are given.

Similarly to local configuration data 811, all the interfaces are given after that. Lines 1705, 1706 and 1707 are identical to the corresponding lines in data 811, and for example line 1708 marks the beginning of the interfaces for host 104. Even though host 104 is new on the network and has not yet had its hardware detected, the network configuration daemon 804 has discovered it. This can serve as an indication to the user that a new host needs detecting.

FIG. 18

FIG. 18 shows the steps performed by network configuration daemon 811. This is part of the storage management system. Since, in a switchable storage environment such as here described, a framestore can be controlled by any one of the hosts, it is necessary for every host to keep up-to-date information regarding the state of the network. Daemon 811 does this.

At step 1801, the daemon is started, during the operating system initialization step of 702, and at step 1802, a local configuration file is loaded into memory. This local configuration file resides on the hard disk and is the data stored as local configuration data 811 at the point when the host shuts down. Similarly, at step 1803, the host data 808, framestore data 809, and storage data 810 is loaded into memory. At step 1804, network configuration data 812 is created.

At step 1805, the daemon waits for an interrupt, and when received, a question is asked at step 1806 as to whether it is an instruction to terminate. If this question is answered in the negative, then the interrupt is processed at step 1807, and control is returned to step 1805 to wait for another interrupt. If the question asked at step 1806 is answered in the affirmative, then at step 1808 an “offline multicast” is sent before the daemon terminates at step 1809. An offline multicast is an announcement on the Ethernet 105 that the host is going offline and so the instruction to terminate only comes when the operating system itself is terminating at step 710.

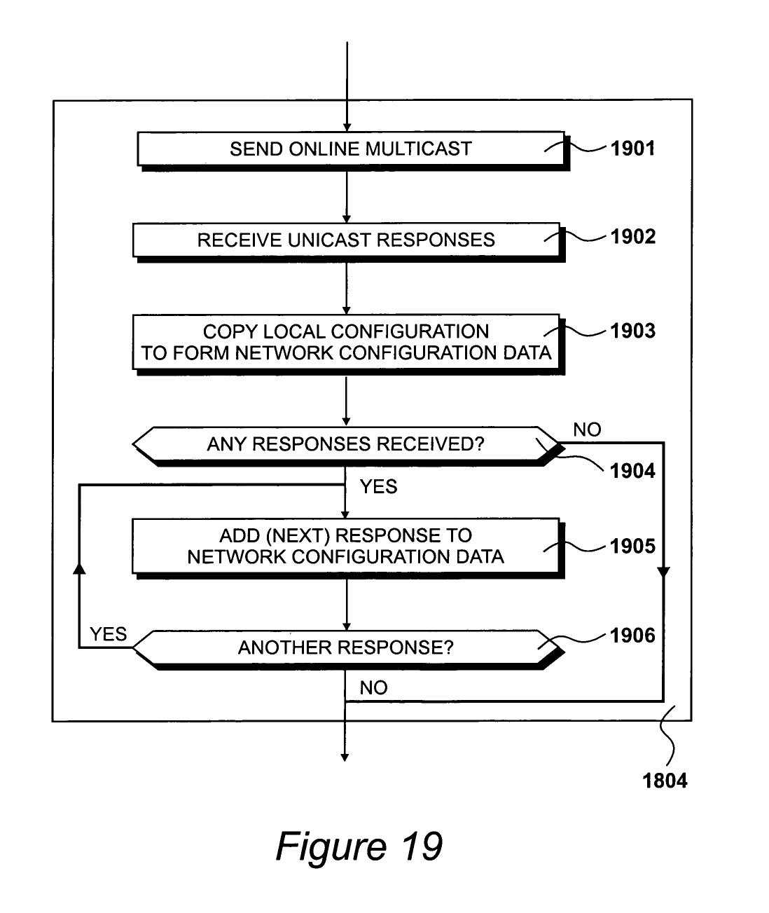

FIG. 19

FIG. 19 details step 1804 at which network configuration data 812 is created. At step 1901, an “online multicast” is sent. This is an announcement on the network that host 102 is online, and takes the form of local configuration data 811. At step 1902, unicast responses are received from all online hosts on the network.

At step 1903, local configuration data 811 is copied to become network configuration data 812, and at step 1904 a question is asked as to whether any responses were received at step 1902. If this question is answered in the affirmative, then the first response is added to the network configuration data 812. Another question is then asked at step 1906, as to whether there is another response. If this question is answered in the affirmative, then control is returned to step 1905 and the next response is added to network configuration data 812. If it is answered in the negative, or if the question asked at step 1904 is answered in the negative, then step 1804 is concluded and network configuration data 812 is complete.

Thus, the construction of network configuration data 812 is dependent upon the hosts that are online on the network and not on any information in host data 808, framestore data 809 or storage data 810, and so hosts are discovered whose hardware has not yet been detected.

FIG. 20

FIG. 20 details step 1807 at which an interrupt received at step 1805 is processed. At step 2001, a question is asked as to whether the interrupt is a date from an application running on host 102. If this question is answered in the affirmative then this date is the modification date of the copy 814 of network configuration data 812 contained in application data 805, and it is a request for an up-to-date version of the data. Thus, another question is asked at step 2002 as to whether the date is the same as the modification date of network configuration data 812. If this question is answered in the negative, then the application is provided with network configuration data 812 at step 2003. If it is answered in the affirmative, then the reply “no update” is provided at step 2004 since the application already has the most recent version of the data.

If the question asked at step 2001 is answered in the negative, to the effect that the interrupt is not a date, then at step 2005 a question is asked as to whether the interrupt is an online multicast from another host on the network. If this question is answered in the affirmative, then at step 2006 network configuration data 812 is updated with the new information contained in the multicast.

If it is answered in the negative, then at step 2007 a further question is asked as to whether the interrupt is an offline multicast from another host on the network. If this question is answered in the affirmative, then at step 2008 the host's details are deleted from network configuration data 812.

If the question asked at step 2007 is answered in the negative, then the interrupt is some other interrupt which is processed at step 2009. At this point, and following any of steps 2003, 2004, 2006 or 2008, step 1807 is concluded.

FIG. 21

FIG. 21 details the steps performed by local configuration daemon 803. Where network configuration daemon 802 keeps network configuration data 812 updated, local configuration daemon 803 keeps local configuration data 811 updated.

At step 2101, the daemon is started during the initialization of the operating system at step 702, and at step 2102, the daemon waits for an interrupt. On receipt, a question is asked at step 2103 as to whether it is an instruction to terminate, as sent by operating system 801 during its termination at step 710. If this question is answered in the negative, then the interrupt is processed at step 2104 and control is returned to step 2102 to wait for another interrupt. If the question is answered in the affirmative, then at step 2105, the daemon saves a copy of the local configuration data 811 to the hard drive as a local configuration file and terminates at step 2106.

FIG. 22

FIG. 22 details step 2104 at which the interrupt received at step 2102 is processed. At step 2201, a question is asked as to whether the interrupt is a notification of a change to the local configuration file stored on the hard drive 327. This may be changed manually, for example when the Ethernet or HiPPI address of the host changes. If this question is answered in the affirmative then at step 2202 local configuration data 811 and network configuration data 812 are updated with the new information.

If the question asked at step 2201 is answered in the negative, then at step 2203, a question is asked as to whether the interrupt is a notification that host 102 has swapped framestores with another host. If this question is answered in the affirmative, then at step 2204 the local configuration file is updated by changing the filesystem ID contained in it. At step 2205, local configuration data 811 and network configuration data 812 are updated, in just the same way as at step 2202. At step 2206, the framestore data 809 is updated by changing the filesystem ID and the RAID IDs and information (all of which is obtained from RAIDs data 1103 and filesystems data 1104 by referencing the new filesystem ID).

If the question asked at step 2203 is answered in the negative, then the interrupt is some other interrupt which is processed at step 2207. At this point, and following steps 2202 or 2206, step 2104 is concluded.

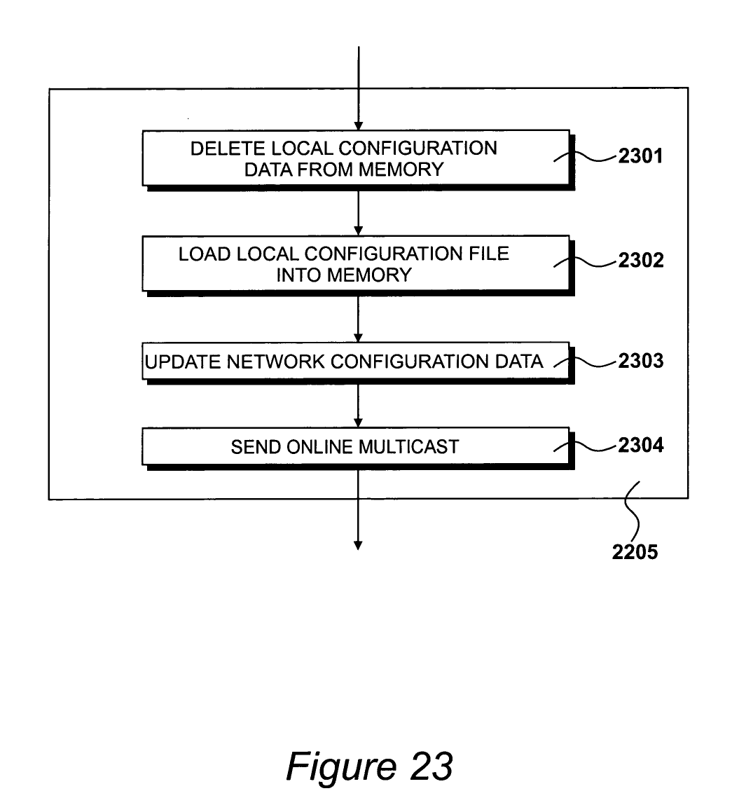

FIG. 23

FIG. 23 details step 2202 at which local configuration data 811 and network configuration data 812 are updated. Step 2205 is identical. At step 2301, local configuration data 811 is deleted from memory and at step 2302, the new local configuration file is loaded into memory as local configuration data 811. At step 2303, the network configuration data 812 is updated with the new information and at step 2304, an online multicast is sent containing the local configuration data 811 so that the other hosts on the network know that the local configuration of host 102 has changed. In this way, the network configuration data on each host is always up to date.

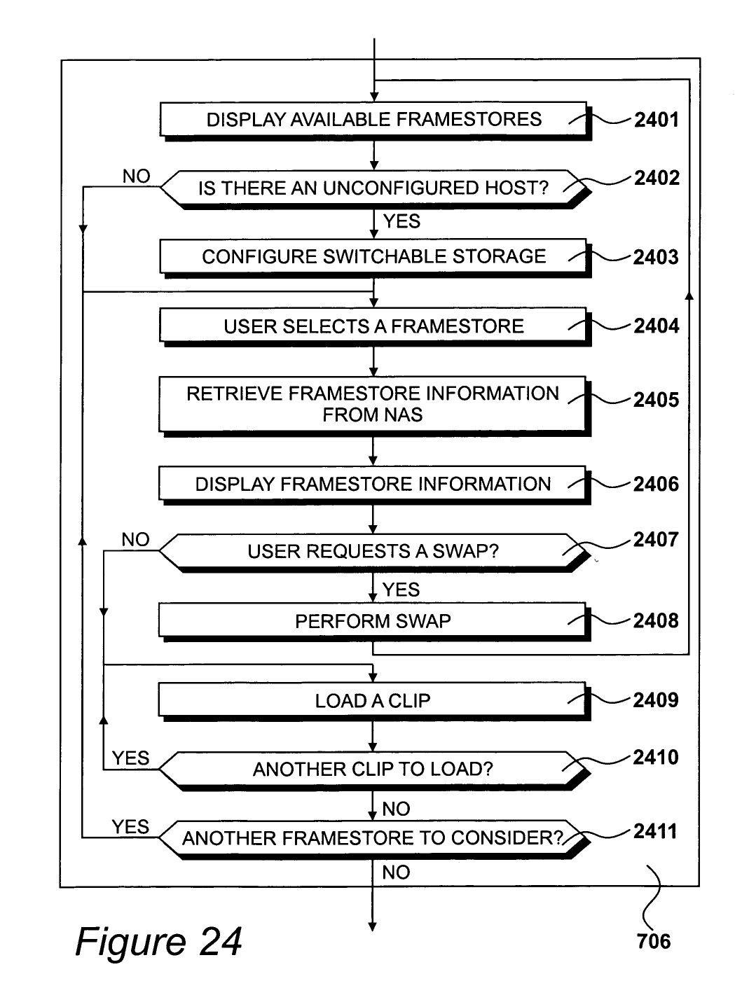

FIG. 24

FIG. 24 details step 706 at which images are loaded from the framestore controlled by host 102 into the memory 322 of host 102.

At step 2401, the framestores connected to the patch panel 107 are displayed to the user, and at step 2402, a question is asked as to whether there is an un-configured host on the network. This is a host that has been discovered by network configuration daemon 811 but for whom no information is found in storage data 809, such as host 104. If this question is answered in the affirmative, then at step 2403 the switchable storage is configured.

Following this, or if the question asked at step 2402 is answered in the negative, at step 2404 the user selects a framestore, and information relating to the contents of that framestore is retrieved from NAS 106 at step 2405 and displayed at step 2406.

At step 2407, a question is asked as to whether the user has requested a framestore swap. If this question is answered in the affirmative, then at step 2408 a swap is performed, and control is returned to step 2401 to display available framestores.

If the question asked at step 2407 is answered in the negative, then at step 2409, a selected clip is loaded into memory 322. At step 2410, a question is asked as to whether the user wishes to load another clip from the selected framestore. If this question is answered in the affirmative, then control is returned to step 2409, and another clip is selected and loaded. If it is answered in the negative, then another question is asked at step 2411 as to whether the user wishes to view another framestore. If this question is answered in the affirmative, then control is returned to step 2404, and the user selects another framestore. If it is answered in the negative, then step 706 is complete and all the presently required images have been loaded ready for manipulation at step 707.

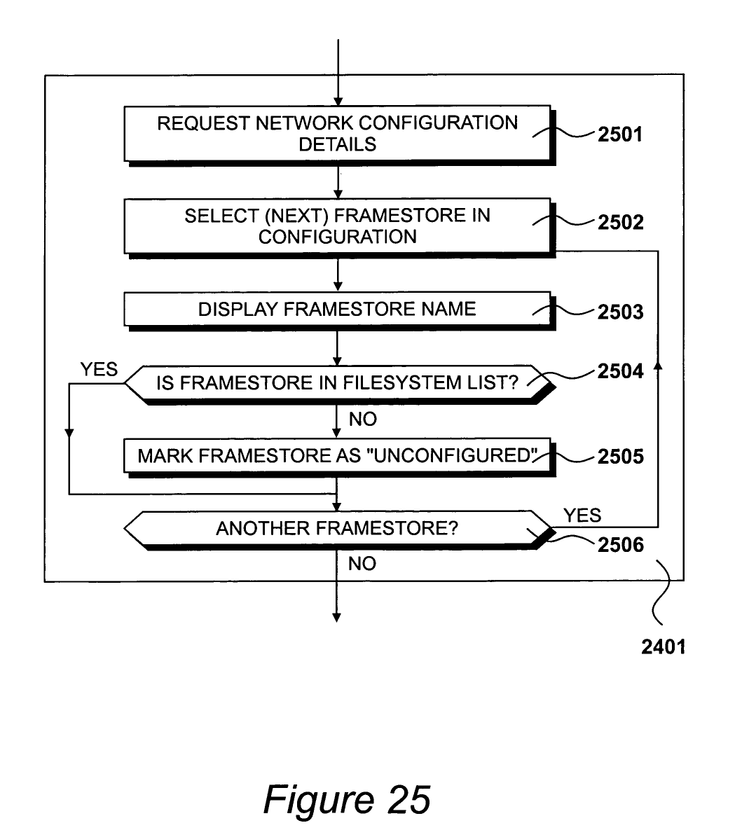

FIG. 25

FIG. 25 details step 2401 at which the available framestores on the network are displayed to the user on VDU 203. At step 2501, network configuration data 812 is received from network configuration daemon 804 by sending it the date of network configuration data 814 stored in application data 805 in memory 322. Either new data is received, replacing data 814 or the message is received that the current data 814 is valid.

At step 2502, the first framestore in data 814 is selected and at step 2503, its name is displayed on VDU 203. At step 2504, a question is asked as to whether this framestore name relates to any of the filesystem objects 1104 stored in storage data 810. If this question is answered in the negative, then the displayed name is marked as un-configured in some way. Following this, and if the question asked at step 2504 is answered in the affirmative, another question is asked at step 2506 as to whether there is another framestore name in data 814. If this question is answered in the affirmative, then control is returned to step 2502 and the next framestore is selected. If it is answered in the negative, then step 2401 is completed and all the online framestores are displayed.

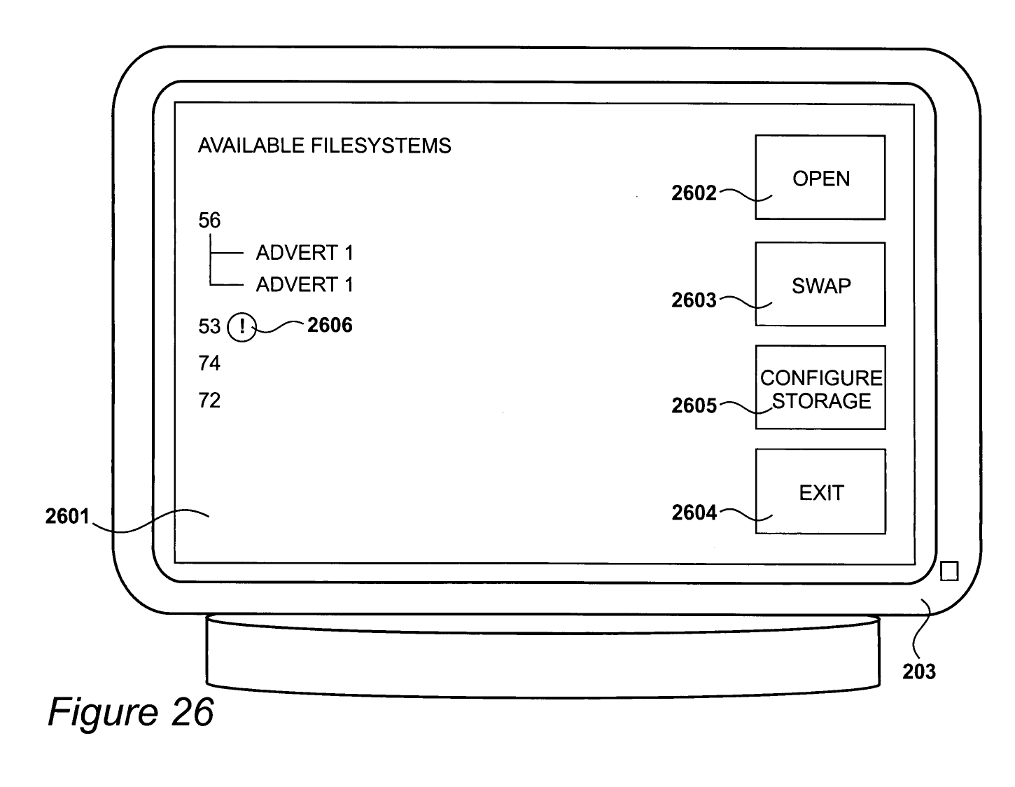

FIG. 26

FIG. 26 illustrates VDU 203 after the completion of step 2401 with the available framestores shown on graphical user interface (GUI) 2601. As an example, the framestore 112 called with the ID 56 is opened with its two projects, “ADVERT 1” and “ADVERT 2” showing. This has resulted from the user selecting button 2602, labeled “OPEN”, and repeated selection of this button will lead to the entire contents of framestore 112 being displayed. If a clip of frames is selected then the selection of button 2602 results in the loading of that clip from storage. If the user wishes to perform a framestore swap then button 2603 should be selected in order to start step 2408, while button 2604 exits GUI 2601 and terminates step 706.

However, before this happens the user notes that the framestore with the filesystem ID 53 is marked as un-configured by icon 2606. It is therefore known that this is a new framestore, and that its hardware and that of the new host (that must also be on the network), has not been detected. The user may therefore select “CONFIGURE STORAGE” button 2605 to start the storage configuration step 2403.

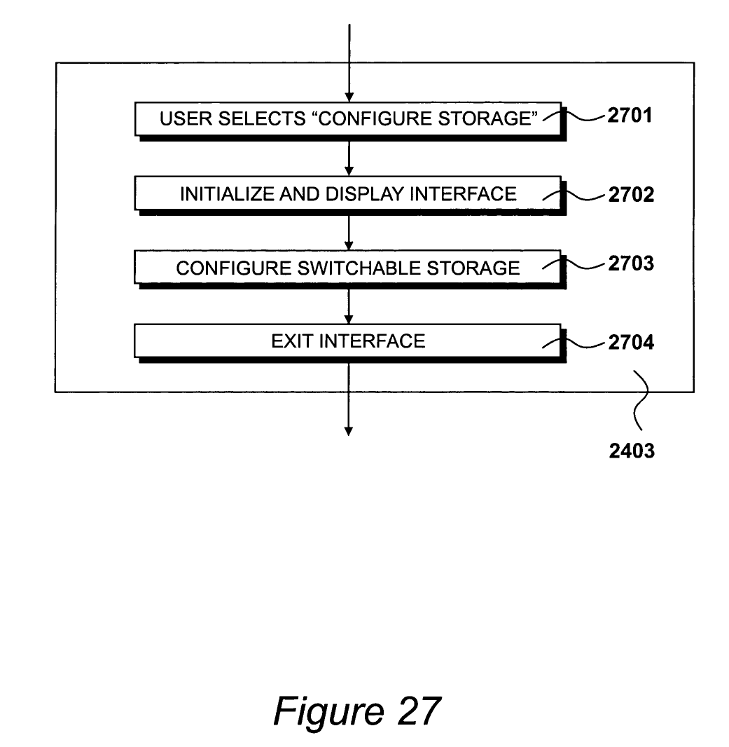

FIG. 27

FIG. 27 details step 2403 at which the switchable storage is configured by detecting hardware settings of hosts and storage devices on the network. At step 2701, the user selects button 2605 in GUI 2601, and at step 2702, a storage GUI is initialized and displayed. At step 2703, the switchable storage is configured, and at step 2704, the GUI is exited.

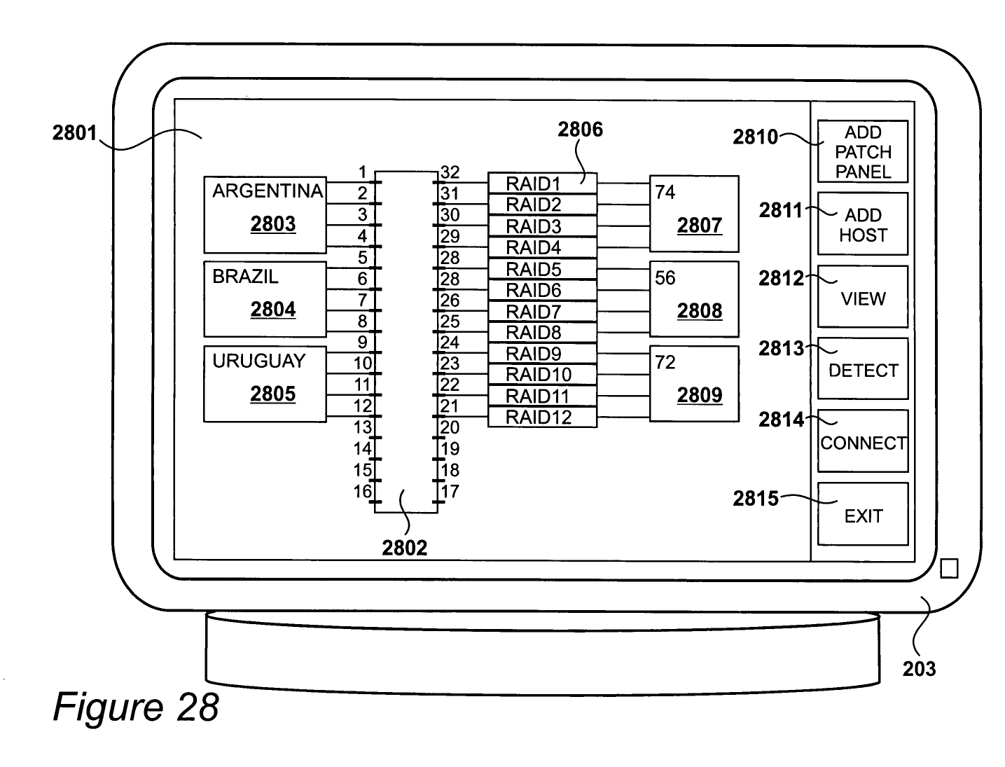

FIG. 28

FIG. 28 shows storage GUI 2801 displayed at step 2702. It includes GUI components for each element of the network whose hardware has been detected by host 102, in other words a component for each object present in storage data 810.

Thus, GUI 2801 includes a patch panel component 2802 corresponding to patch panel object 1201, which refers to patch panel 107. GUI 2801 also includes three host components 2803, 2804 and 2805 corresponding to host objects 1301, 1302 and 1303 respectively which contain data relating to hosts 101, 102 and 103 respectively. These hosts are shown connected to the patch panel according to the number of adapters in the host object and the ports given there.

Also included are twelve RAID objects corresponding to the RAID objects in RAIDs data 1103, for example RAID component 2806 corresponds to RAID object 1401, which as shown in FIG. 14 is connected to port 32.

Finally, included are three filesystem components 2807, 2808 and 2809 which correspond to the three filesystem objects 1501, 1502 and 1503 respectively, which contain data relating to framestores 111, 112 and 113 respectively. These are shown connected to the RAIDs which comprise them.

Thus, the display in GUI 2801 is a representation of the network as contained in storage data 810. The functions available to the user to configure the storage are accessible via the buttons. Button 2810 facilitates the addition of a patch panel component and button 2811 facilitates the addition of a host component. Button 2812 displays, for a selected component, the object that it represents so that the user can view the data therein and button 2813 detects, for a selected host object, the hardware for it and its connected framestore. Button 2814 facilitates the making of connections between components and button 2815 exits the GUI and terminates step 2403.

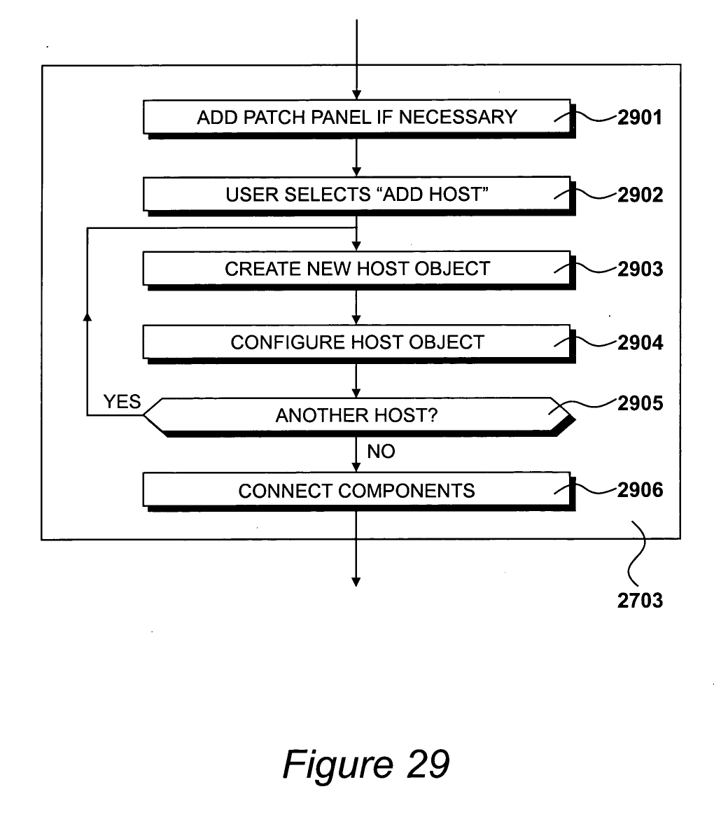

FIG. 29

FIG. 29 details step 2703 at which the switchable storage is configured using GUI 2801. At step 2901, a new patch panel component is added if necessary, and at step 2902, the user selects button 2811 to add a new host. At step 2903, a new host object is created in hosts data 1102 and at step 2904, the host object is configured, including the detection of its hardware, its respective framestore and the framestore's hardware. At step 2905, a question is asked as to whether there is another host to be added. This information is obtained by viewing the GUI 2601, since any framestore on the network which has not been configured is indicated as shown by marking 2606. If this question is answered in the affirmative by the user again selecting button 2811, then control is returned to step 2903 and another host object is created. If it is answered in the negative, then at step 2906 the new components are connected and step 2703 is complete.

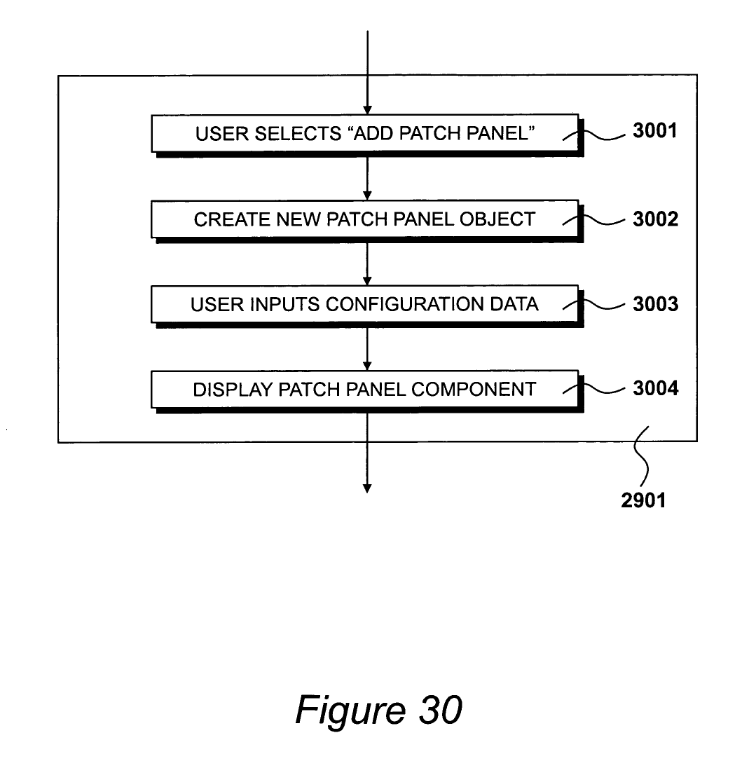

FIG. 30

FIG. 30 details step 2901 at which a new patch panel object is added. This step would normally only be carried out during the configuration of a new host, for example host 104, when it first comes onto a network. At step 3001, the user selects button 2810, and at step 3002 a new patch panel object is created in patch panels data 1101. At step 3003, the user inputs the necessary configuration data for the patch panel, including the number of ports, and at step 3004, a patch panel component corresponding to the new object is displayed.

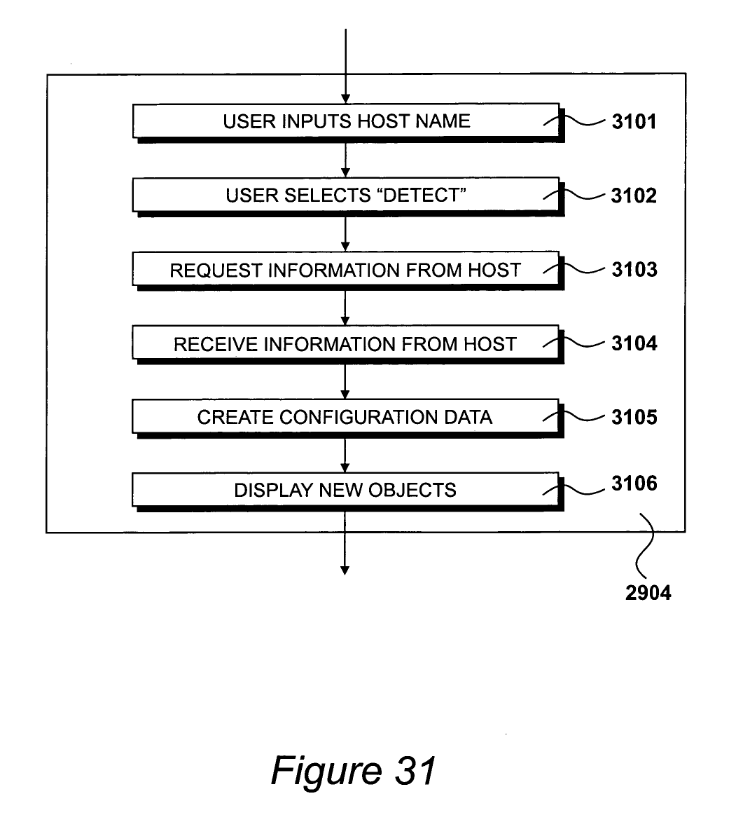

FIG. 31

FIG. 31 details step 2904 at which a new host object is configured. At step 3101, the user enters the name of the host and at step 3102, the user selects the “DETECT” button 2813. At step 3103, the necessary information is requested from the specified host. This is done by a multicast to the address of the host as identified within the copy 814 of network configuration data 812. At step 3104, host data and framestore data is received from the new host and at step 3105, they are used to create the necessary storage data. At step 3106, components are displayed in GUI 2801 that correspond to the new host object and any new storage or filesystem objects created.

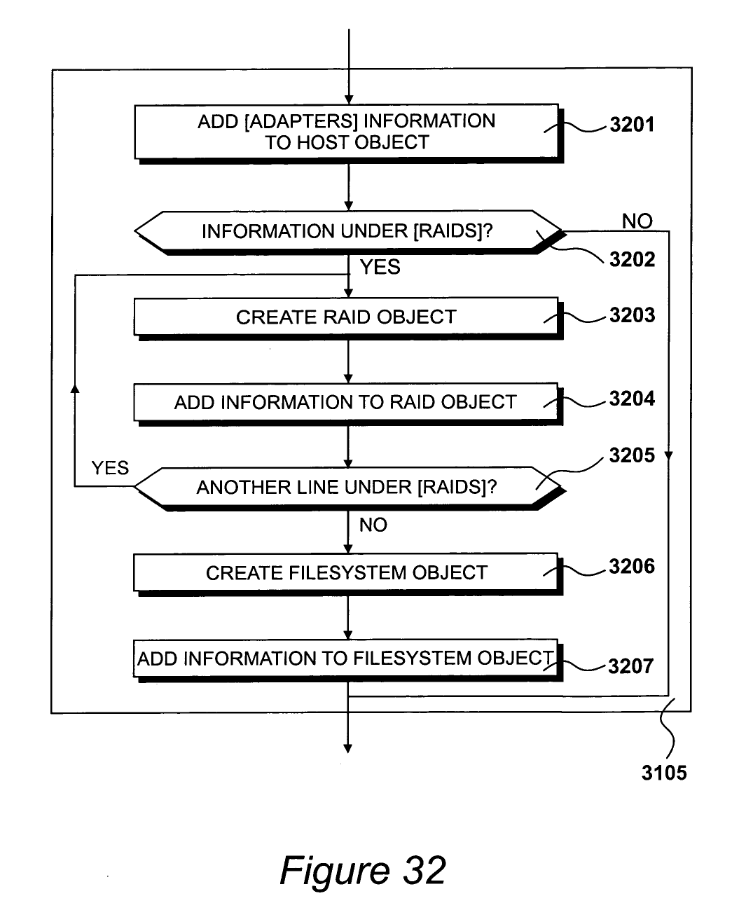

FIG. 32

FIG. 32 details step 3105 at which the storage data for the new host is created after the host has sent its host data and framestore data. A host object has already been created and named by the user and so at step 3201, the adapters information in the host data is added to the host object.

At step 3202, a question is asked as to whether there is any RAID information in the framestore data that has been received. If this question is answered in the affirmative, then at step 3203 a new RAID object is created in RAIDs data 1103 and the necessary information from the framestore data, such as the RAID ID, the filesystem ID, the number of drives, the size of the drives, its gigabit setting and the port it is connected to, is added to the object at step 3204. At step 3205, another question is asked as to whether there is another line of RAID data and if this question is answered in the affirmative, then control is returned to step 3203 and a new RAID object is created.

If it is answered in the negative, then at step 3206, a new filesystem object is created. A filesystem object must exist if there are new RAIDs. At step 3207, the necessary information from the framestore data, such as the filesystem ID and the IDs of the RAIDs that make it up, are added to the object.

At this point, and if the question asked at step 3202 is answered in the negative, step 3105 is concluded and the host object has been configured.

These steps have been described with reference to host 102, which sees a new host come onto the network and needs to configure it, and similar steps are carried out by hosts 101 and 103. Host 104, as the new host, must also carry out this process but must first add a patch panel object and then add all four hosts, including itself, using this method. Once all four hosts have carried out this configuration task the switchable storage is fully operational.

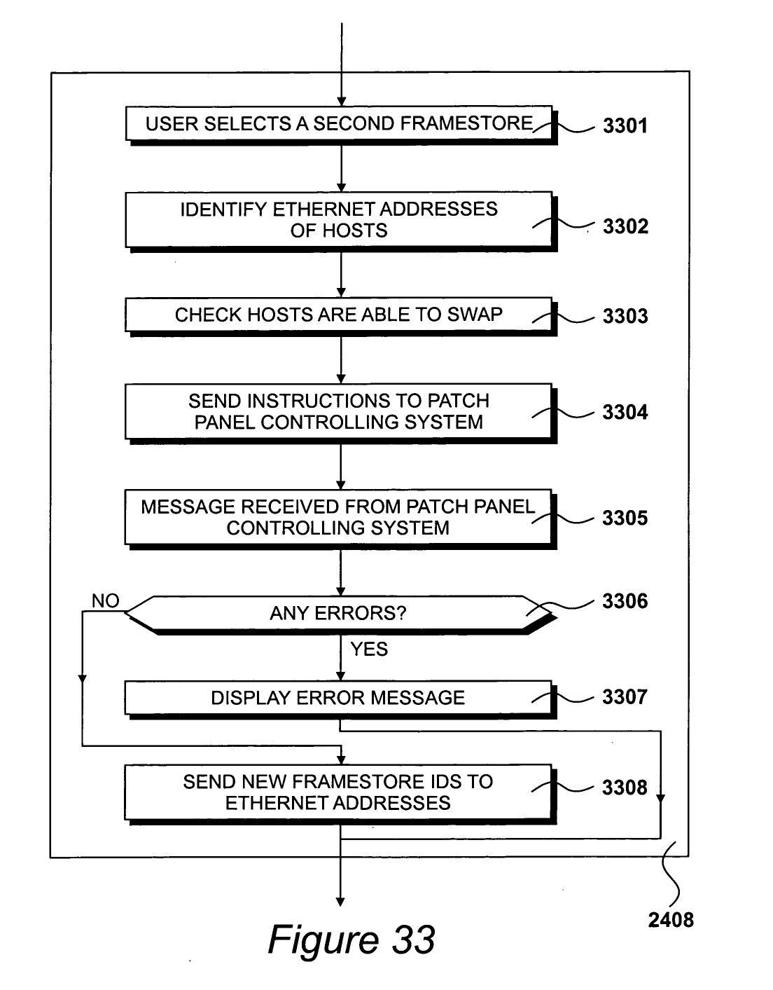

FIG. 33

FIG. 33 details step 2408 at which a framestore swap is performed. This is initiated by the user selecting a framestore and selecting button 2603 in GUI 2601. Thus at step 3301, the user selects a second framestore for the swap. Neither of the framestores need be the one currently connected to host 102, since a swap of any framestores can be initiated from any host.

At step 3302, the Ethernet addresses of the hosts currently connected to the framestores are identified from network configuration data 812 and at step 3303, a check is performed on storage data 810 that the hosts are able to swap, for example that the gigabit settings of the hosts and their prospective framestores are not incompatible.

At step 3304, instructions are sent to patch panel 107 over Ethernet 105 to connect certain ports together and at step 3304, a message is received back from patch panel 107 confirming the connections. At step 3306, a question is asked as to whether this message indicates any errors. If this question is answered in the affirmative, then the errors are displayed to the user on VDU 203 at step 3307, but if it is answered in the negative, then each host is sent, by a unicast over ethernet 105, the filesystem ID of the framestore that it now controls at step 3308. On each host the local configuration daemon receives this message and updates the local configuration data and framestore data in its own memory.

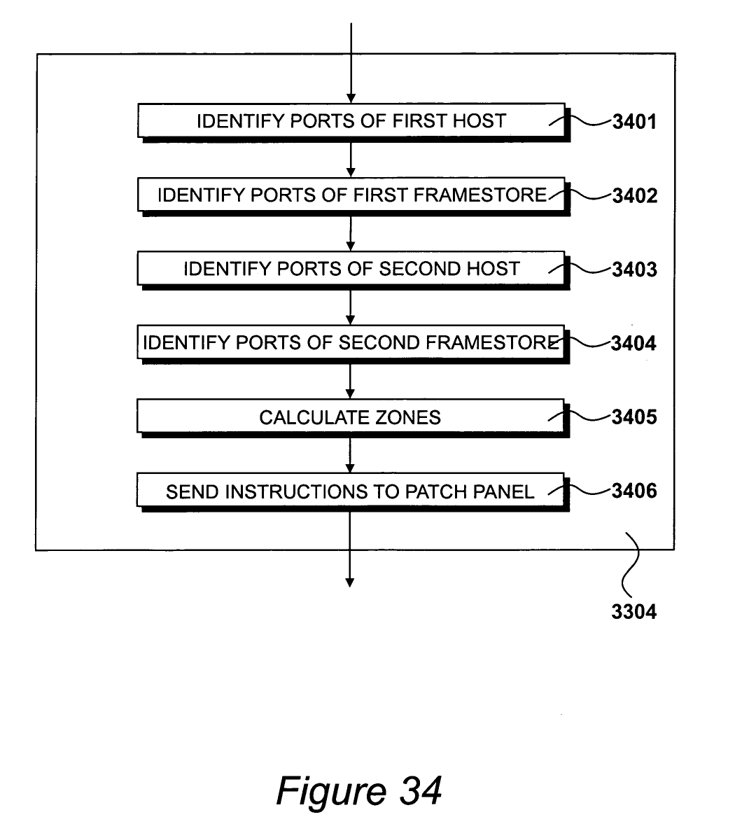

FIG. 34

FIG. 34 details step 3304 at which swap instructions are sent to patch panel 107. At step 3401, the ports on the patch panel to which the first host is connected are identified from hosts data 1102 and at step 3402, the ports for the framestore to which it is currently connected are obtained from RAIDs data 1103 and filesystem data 1104. Similarly, at step 3403, the ports for the second host are identified and at step 3404, the ports for the framestore to which it is currently connected are identified.

At step 3405, zones are calculated for the framestore swap. As discussed with reference to FIG. 6, either one-port, two-port or three-port zones are created when connections are made within patch panel 107. Finally, at step 3406, specific instructions to connect the outputs of each identified port to the input of another port are issued to patch panel 107 over Ethernet 105. By connecting the ports in this way the patch panel will perform a framestore swap.

1. A data processing apparatus, comprising:
(a) a switch;
(b) a plurality of storage devices, wherein each storage device is connected to said switch;
(c) a plurality of host computers, wherein each host computer:
(i) is connected to said switch such that each host computer is provided with switchable storage;
(ii) has internal storage on which is stored:
(1) first data that is necessary for said communication between itself and the storage devices to which it is connected; and
(2) second data that relates to at least one of said host computers and storage devices;
(iii) is configured to identify each of said host computers that is missing from said second data; and
(iv) is configured to request said first data from each of said identified host computers in order to construct said second data.

2. The apparatus according to claim 1, wherein each host computer includes adapters and said first data includes information on the adapters that are connected to said switch.

3. The apparatus according to claim 2, wherein said information includes the gigabit characteristics of said adapters and the ports of said switch to which said adapters are connected.

4. The apparatus according to claim 1, wherein for each said host computer, said first data includes information on the framestore currently controlled by said host.

5. The apparatus according to claim 4, wherein said information includes characteristics of the storage devices making up said framestore, including at least one port on said switch to which each device is connected.

6. The apparatus according to claim 5, wherein said characteristics of said storage devices include the number of disk drives, the capacity of said disk drives and the gigabit characteristic of said storage device.

7. The apparatus according to claim 1, wherein each of said hosts includes a display means on which said second data may be represented graphically.

8. A method of configuring a switchable storage environment comprising:
storing, in internal data on each of a plurality of host computers, first data necessary for communication between the host computer containing the internal data and one or more storage devices to which the host computer is connected, wherein each host computer is connected to a plurality of storage devices, a plurality of host computers, and a switch;
storing, in the internal data on each host computer, second data that relates to at least one of the plurality of host computers and one of the plurality of storage devices;
each of the plurality of host computers identifying each of said host computers that is missing from said second data; and
each of the plurality of host computers requesting said first data from each of said identified host computers in order to construct said second data.

9. A method according to claim 8, wherein each host computer includes a plurality of adapters and said first data includes information on the adapters that are connected to said switch.

10. A method according to claim 9, wherehn said information includes the gigabit characteristics of said adapters and the ports of said switch to which said adapters are connected.

11. A method according claim 8, wherein for each of said host computers said first data includes information on the framestore currently controlled by said host computer, wherein a framestore is composed of one or more of said storage devices.

12. A method according to claim 11, wherein said information includes characteristics of the storage devices making up said framestore, including at least one port on said switch to which each device is connected.

13. A method according to claim 12, wherein said characteristics of said storage devices include the number of disk drives, the capacity of said disk drives and the gigabit characteristic of said storage device.

14. A method according to claim 8, including the step of displaying said second data graphically on a display means.
